(19) United States
(12) Patent Application Publication
(10) Pub. No.: US 2025/0348800 A1
(43) Pub. Date: Nov. 13, 2025

(54) Systems and Methods for Seamless Feedback Between Aviation Services and Multimodal Transportation Services

(71) Applicant: Joby Aero, Inc., Santa Cruz, CA (US)

(72) Inventors: Ian Andreas Villa, San Francisco, CA (US); Raphael Max Lurie, San Francisco, CA (US); Adam Warmoth, Los Angeles, CA (US)

(21) Appl. No.: 19/274,244

(22) Filed: Jul. 18, 2025

Related U.S. Application Data
(63) Continuation of application No. 17/765,576, filed on Mar. 31, 2022.
(60) Provisional application No. 63/000,278, filed on Mar. 26, 2020.

(51) Int. Cl. G06Q 10/02; G06Q 50/40

(52) U.S. Cl. CPC G06Q 10/025; G06Q 50/40

(57) ABSTRACT

Systems and methods are directed to perform operations to optimize the provision of user services. The operations can include obtaining user data for a user of a multimodal transportation service provider. The operations can include obtaining, based at least in part on the user data, aviation data for one or more aviation service providers, the one or more aviation service providers comprising at least one of a flight facility operator or an airline operator. The operations can include determining, based at least in part on the user data and the aviation data, one or more service actions, the one or more service actions comprising at least one of a multimodal transportation service itinerary adjustment, a security process modification, or a user service optimization. The operations can include performing the one or more service actions.

### PRIORITY CLAIM

The present application is a continuation of U.S. Provisional application Ser. No. 17/765,576 having a filing date of Mar. 31, 2022, which is a national stage application of International Application No. PCT/US2021/024149 having a filing date of Mar. 25, 2021, which is based on and claims benefit of U.S. Provisional Application 63/000,278 having a filing date of Mar. 26, 2020. Applicant claims priority to and the benefit of each of such applications and incorporates all such applications herein by reference in its entirety.

### FIELD

The present disclosure relates generally to facilitating seamless trip flow between aviation services. More particularly, the present disclosure relates to systems and methods that optimize services provided to users based on data shared between multimodal transportation service providers and aviation service providers.

### BACKGROUND

Multimodal transportation service providers and aviation service providers offer services to users that can be customized and/or optimized based on user information (e.g., modifying an airline food offering based on user dietary preferences, etc.). However, these service providers generally lack the capability to efficiently facilitate user information amongst each other. Thus, transportation and aviation service providers generally lack the user information (e.g., arrival times, user preferences, etc.) required to modify aspects of their respective services.

### SUMMARY

Aspects and advantages of embodiments of the present disclosure will be set forth in part in the following description, or can be learned from the description, or can be learned through practice of the embodiments.

One example aspect of the present disclosure is directed to a computing system. The computing system can include one or more processors and one or more memories including instructions that, when executed by the one or more processors, cause the one or more processors to perform operations. The operations can include obtaining user data for a user of a multimodal transportation service provider. The user data can include one or more user characteristics associated with the user. The operations can include obtaining, based at least in part on the user data, aviation data for one or more aviation service providers. The aviation data can include one or more aviation service characteristics associated with each aviation service provider of the one or more aviation service providers. The one or more aviation service providers can include at least one of a flight facility operator or an airline operator. The operations can include determining, based at least in part on the user data and the aviation data, one or more service actions. The one or more service actions can include at least one of a multimodal transportation service itinerary adjustment, a security process modification, or a user service optimization. The operations can include performing the one or more service actions.

Another example aspect of the present disclosure is directed a computer-implemented method for optimizing aviation services. The method can include obtaining, by a computing system comprising one or more computing devices, passenger data for one or more users of a multimodal transportation service provider, the passenger data including one or more passenger characteristics associated with each user of the one or more users of the multimodal transportation service provider. The method can include determining, by the computing system and based at least in part on the passenger data, one or more aviation services to be provided to at least one of the one or more users by one or more aviation service providers, the one or more aviation service providers including at least one of a flight facility operator or an airline operator. The method can include determining, by the computing system and based at least in part on the passenger data, one or more aviation service modifications, the one or more aviation service modifications configured to modify one or more service characteristics associated with at least one aviation service of the one or more aviation services. The method can include performing, by the computing system, the one or more aviation service modifications.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example infrastructure system for multimodal transportation service optimization and aviation service optimization according to example embodiments of the present disclosure.

FIG. 2 depicts an example transportation segments and contingency transportation segments of a multimodal transportation service according to example embodiments of the present disclosure.

FIG. 3 depicts an example multimodal transportation service itinerary according to example embodiments of the present disclosure.

FIG. 4 depicts an example of user data according to example embodiments of the present disclosure.

FIG. 5 depicts an example of passenger data according to example embodiments of the present disclosure.

FIG. 6 depicts an example of aviation data according to example embodiments of the present disclosure.

FIG. 7 depicts a flowchart diagram of an example method of optimizing multimodal transportation services according to example embodiments of the present disclosure.

FIG. 8 depicts a flowchart diagram of an example method for generating an aviation data request according to example embodiments of the present disclosure.

FIG. 9 depicts a flowchart diagram of an example method of optimizing aviation services according to example embodiments of the present disclosure.

FIG. 10A depicts an example user device interface for displaying contingency transportation segments to a user according to example embodiments of the present disclosure.

FIG. 10B depicts an example user device interface for displaying terminal map data to a user according to example embodiments of the present disclosure.

FIG. 11 depicts example system components according to example embodiments of the present disclosure.

### DETAILED DESCRIPTION

Example aspects of the present disclosure are directed to improved systems and methods for optimizing multimodal transportation services based on aviation service information. For instance, a multimodal transportation service provider can manage and coordinate a plurality of different types of vehicles to provide services to a plurality of users via a transportation platform. By way of example, a user may generate a service request for transportation from an origin location to a destination location via an application running on the first user's device (e.g., mobile phone, etc.). An operations computing system associated with the service provider (e.g., a cloud-based operations computing system, etc.) can obtain data indicative of the service request and generate a user itinerary to facilitate transporting the first user from the origin location to the destination location. The itinerary can be a multimodal transportation itinerary that includes at least two types of transportation such as, for example, ground-based vehicle transportation and aerial transportation. For example, the itinerary can include three legs: a first leg that includes a ground-based vehicle transporting the first user from the origin location (e.g., a home, etc.) to a first aerial transport facility (e.g., a first VTOL vertiport); a second leg (e.g., an aerial portion) that includes an aerial vehicle transporting the first user from the first aerial transport facility to a second aerial transport facility (e.g., a second VTOL vertiport); and a third leg that includes another ground-based vehicle transporting the first user from the second aerial transport facility to the destination location (e.g., an airport).

Other aspects of the present disclosure improve and optimize the provision, efficiency, user experience, itinerary generation, and other aspects of the multimodal transportation service based on aviation data received from an aviation service provider. To help do so, the operations computing system can obtain user data for a user of the multimodal transportation service provider (e.g., a rideshare service provider, etc.). The user data can include one or more user characteristics associated with the user (e.g., user preferences, user status, security status, etc.). Based on the user data, the operations computing system can obtain aviation data for one or more aviation service providers (e.g., airport operators, airline operators, etc.). The aviation data can include one or more aviation service characteristics associated with the aviation service provider(s) (e.g., airport terminal map, onboard seating arrangements/food offerings, etc.). Based on the user data and the aviation data, the operations computing system can determine and perform one or more service actions (e.g., user itinerary adjustments, security process modifications, user service optimizations, etc.). As an example, the operations computing system can obtain use data that indicates a user prefers window seats during flights. Based on the user data, the operations computing system can obtain aviation data that indicates that a user is scheduled for a flight service. The operations computing system can perform a user service optimization by sending a request to an airline service provider that the user be moved to a window seat.

According to another aspect of the present disclosure, example systems and methods described herein are directed to optimizing aviation services based on multimodal transportation service information. More particularly, other aspects of the present disclosure are directed to a computer-implemented method for optimizing aviation services provided to a user based on data received from a transportation service provider. A computing system can obtain passenger data for one or more users of a multimodal transportation service provider. The passenger data can include one or more passenger characteristics associated with each user (e.g., luggage weight, security data, itinerary data, etc.). Based on the passenger data, one or more aviation services (airport services, flights, etc.) can be determined to be provided to the one or more users. The aviation services can be provided by aviation service providers (e.g., flight facility operators, airline operators, etc.). Aviation service modifications can be determined based on the passenger data. The aviation service modifications can include the modification of service characteristic(s) (e.g., departure times, seating arrangements, boarding orders, onboard food options, airport security processes, etc.) associated with the one or more aviation services. As an example, passenger data can be obtained that indicates that a user offered a certain flight service possesses a severe nut allergy. Based on the passenger data, aviation service modifications can be determined that remove nut-based food products from the food products offered on-board the flight service.

The technology of the present disclosure provides a more efficient approach to providing multimodal transportation services and aviation services to users. As an example, a multimodal transportation service can modify a multimodal transportation itinerary (e.g., remove a transportation segment, add a transportation segment, etc.) based on aviation data (e.g., a departure time delay, boarding order rearrangement, etc.) received from an aviation service provider. As another example, an aviation service provider (e.g., an airline operator, etc.) can receive user data (e.g., user luggage weight, security permissions, etc.) from a multimodal transportation service provider. Based on the user data, the aviation service provider can modify characteristics of an aviation service (e.g., flight service seating arrangements, flight service food offerings, etc.) provided to the user. In this manner, both aviation service providers and multimodal transportation service providers can more efficiently plan and operate transportation services for users.

More particularly, an operations computing system of a multimodal transportation service provider can obtain user data for a user. User data can be obtained from a user device associated with the user, computing system(s) associated with the multimodal transportation service provider, transportation vehicles and/or facilities associated with the multimodal transportation service provider, food delivery services associated with the multimodal transportation service provider, etc. The user data can include one or more user characteristics associated with the user.

In some implementations, the one or more user characteristics can include historical user data. Historical user data can indicate historical user preferences, statuses, and/or other historical user behavior(s) associated with the user's previous utilization of the multimodal transportation service. As an example, historical user data may indicate that a user is historically late or early when utilizing the multimodal transportation service. As another example, historical user data may indicate that a user generally prefers or avoids one or more modes of transportation (e.g., autonomous ground-based vehicles, aerial vehicles, etc.). As yet another example, historical user data may indicate that the user prefers or avoids certain types of foods (e.g., dietary preferences, etc.). It should be noted that, in some implementations, the collection and/or generation of historical user data by the multimodal transportation service provider can be opted out of by the user. In other implementations, the collection and/or generation of historical user data cannot occur without obtaining explicit permission from a user (e.g., through an application associated with the multimodal transportation service, etc.).

In some implementations, the one or more user characteristics can include user status data. User status data can indicate user information, user luggage weight, user location, person(s) associated with the user, and any other sort of information describing current aspect(s) of the user. As an example, user status data can include user accommodations/information (e.g., medical conditions, disabilities, height, weight, etc.). As another example, user status data can include the location of the user (e.g., along the multimodal transportation route). The user status data can, for example, indicate one or more persons associated with the user (e.g., friends, family members, etc.).

In some implementations, the one or more user characteristics can include user security data. User security data can, in some implementations, be obtained at a transportation facility associated with the multimodal transportation service provider (e.g., a VTOL vertiport, etc.) and/or in association with governmental security services (e.g., the Transportation Security Administration, etc.). The user security data can indicate a security clearance level associated with the user. As an example, the user security data can indicate that a user has undergone security procedure(s) (e.g., at a multimodal transportation service facility, etc.) of a sufficient security level to bypass subsequent governmental security checks (e.g., airport security checks, etc.). In such fashion, the user security data can be utilized to eliminate redundant security process(es) of the multimodal transportation service provider and/or the aviation service provider(s).

In some implementations, the one or more user characteristics can include user preference data. User preference data can be provided by the respective user and/or obtained from historical user data. User preference data can indicate user preferences, such as preferred dietary choices (e.g., vegetarian options, etc.), flight seating arrangements (e.g., a preference for window seats), and any other preference(s) associated with services provided by the multimodal transportation service and/or the aviation service provider(s). As an example, user preference data can indicate that a user prefers an aisle seat with a certain amount of legroom. As another example, user preference data can indicate that a passenger prefers certain amenities associated with a flight service (e.g., food offerings, drink offerings, entertainment offerings, etc.).

The operations computing system of the multimodal transportation service provider can obtain aviation data for one or more aviation service providers. Aviation service providers can include airline operator(s) (e.g., regional and/or national airlines, etc.), flight facility operators (e.g., airport operators, vertiport operators, etc.), and/or other types of aviation service providers. In some implementations, the aviation data can be obtained by generating an aviation data request based at least in part on the user data. The aviation data request can be configured to request the aviation data from the one or more aviation data service providers. As an example, the operations computing system of the multimodal transportation service can, in some implementations, receive a message format for the aviation data request (e.g., a particular Javascript Object Notation format, HTTP method, verification key, etc.) based on one or more calls to an application programming interface associated with the airline service provider(s). The operations computing system can generate and send an aviation data request based on the user data and the message format. The aviation data request can be configured to request the aviation data from the aviation service provider(s) based at least in part on the user data and by including at least a portion of the user data in the request. The aviation data can be received by the operations computing system of the multimodal transportation service provider in response to the aviation data request.

The aviation data can include one or more aviation service characteristics (e.g., flight facility maps, airline itineraries, etc.) associated with each aviation service provider of the one or more aviation service providers. In some implementations, the aviation service characteristic(s) can include flight facility operator mapping data. Flight facility operator mapping data can include a mapped representation of a flight facility. The mapping data can represent the flight facility using any preferred perspective, dimensionality, and/or level of interactivity. As an example, the mapping data can include a static, top-down, two-dimensional representation of a flight facility and the various services (e.g., restaurants, terminals, family friendly bathrooms, etc.) offered inside and/or around the flight facility. As another example, the mapping data can include a three-dimensional, interactive representation of the flight facility that can be modified (e.g., highlighting the location of a service, etc.) based on received inputs (e.g., a user input, etc.). As yet another example, the mapping data can include a virtual reconstruction of the flight facility that is navigable from a user computing device (e.g., a virtual “tour” of the flight facility, etc.).

In some implementations, the flight facility mapping data can more particularly include additional information regarding the service(s) provided by the flight facility operator. As an example, the flight facility mapping data can include menus for restaurants located in the flight facility and/or products offered in various shops located in the flight facility. In some implementations, as will be discussed in greater detail with regard to the figures, the flight facility operator mapping data can be provided to a user device for display to the user in an interactive manner. The user can interact with the displayed mapping data to communicate service requests to the multimodal transportation service provider (e.g., through an associated application, etc.) and/or service providers associated with the multimodal transportation service provider (e.g., food ordering services, autonomous food delivery services, etc.). As an example, if mapping data provided for display to the user includes a menu for a restaurant located in the flight terminal, the user can interact with the menu to request food be prepared in advance for the user. The user request can be received by the multimodal transportation service provider and, in some implementations, can be communicated to the flight facility operator and/or associated service provider(s) (e.g., restaurants, shops, etc.).

In some implementations, the aviation service characteristic(s) can include flight facility operator capability data that describes one or more capabilities of the flight facility operator. Operator capabilities can include flight facility transportation services (e.g., trams, shuttles, taxis, terminal parking, etc.), handicap accessibility (e.g., wheelchair ramps, medical accommodations, etc.), food offerings (e.g., vegetarian options, allergen-free options, etc.), offered services (e.g., travel agents, currency exchanges, customer services, etc.), or any other capabilities of the flight facility operator. As an example, the flight facility operator capability data can indicate that a flight facility does possesses the accessibility infrastructure necessary to service a quadriplegic user. As another example, the flight facility operator capability data can indicate that a flight facility operator provides multiple food offerings for users with severe nut allergies. In addition, the operator capability data can indicate whether a flight facility allows for direct air transportation of users. As an example, the capability data can indicate that an aerial vehicle of the multimodal transportation service (e.g., a helicopter, a VTOL craft, etc.) can land in or on an area of the flight facility (potentially beyond a security checkpoint).

In some implementations, the aviation service characteristic(s) can include airline capability data. Airline capability data can describe the capabilities of the airline operator in a substantially similar fashion as the flight facility operator capability data, as discussed above. Further, the airline capability data can indicate specific capabilities of the flight services of the airline operator (e.g., in-flight entertainment offerings, seats with more leg room, first class upgrades, etc.). For example, the airline capability data may indicate that a flight service of the airline operator has food offerings for passengers with certain food restrictions, or that a flight service is wheelchair accessible. In addition, the airline capability data can indicate whether the airline permits users to disembark an aerial vehicle of a multimodal transportation service and directly board a flight service of the airline operator.

In some implementations, the aviation service characteristic(s) can include airline itinerary data. Airline itinerary data can describe a departure time, departure location, arrival time, boarding order, and/or arrival location of a flight service provided by the airline operator. The airline itinerary data can also describe any modifications to the aforementioned aspects of the flight service. As an example, the airline itinerary data can indicate that a flight service has a departure time of 3:00 pm at a terminal 15 of a flight facility. As another example, the airline itinerary data can indicate that the flight service departure time has been modified to 3:45 p.m. In such fashion, the aviation service characteristics can indicate any changes or modifications (e.g., delays, early arrivals, etc.) to airline service(s) offered to the user.

As described herein, a user can request a multimodal transportation service to travel from an origin to a destination such as, for example, the flight facility (e.g., airport) to board a flight offered by the flight operator. In response, the operations computing system can generate a multimodal transportation itinerary for the user. A multimodal transportation service itinerary can include two or more transportation segments. A transportation segment can include a start time, an end time, a start location, a destination location, and a mode of transportation to implement the transportation segment. As an example, a first transportation segment can include ground-based transportation (e.g., via a human driven car), a start time of 3:00 p.m., a start location of a user's residence, an end time of 3:45 p.m., and a destination location of an aerial transportation facility (e.g., a vertiport, a helipad, etc.) associated with the multimodal transportation service provider. Transportation segments can be added and/or removed from the multimodal transportation service itinerary, and can be implemented by utilizing any sort of autonomous or non-autonomous transportation vehicle (e.g., ground-based vehicle, aerial vehicle, water-based vehicle, etc.).

The operations computing system of the multimodal transportation service can determine one or more service actions to perform based on the user data and the aviation data. Service action(s) can include multimodal transportation service itinerary adjustment(s). In some implementations, multimodal transportation service itinerary adjustment(s) can include adjusting at least one of the start time, the end time, the start location, the destination location, and/or the mode of transportation for at least one transportation segment of the itinerary. As an example, an itinerary adjustment may adjust a start time for a transportation segment from 3:15 p.m. to 3:45 p.m. because the user status data includes a user location that indicates the user will not arrive to the start location on time.

In some implementations, the multimodal transportation service itinerary adjustment(s) can include generating one or more contingency transportation segments for a transportation segment of the itinerary. More particularly, contingency transportation segment(s) can correspond with a transportation segment if the contingency segment provides an alternative for the transportation segment. The contingency transportation segment(s) can differ from the transportation segment in any manner (e.g., start time, end time, destination location, start location, mode of transportation, etc.). If a plurality of contingency transportation segments are generated, each contingency transportation segment of the plurality of contingency transportation segments can differ in at least one aspect (e.g., start time, end time, destination location, etc.). As an example, a transportation segment can include a start time of 3:00 p.m and a first route. A contingency transportation segment can be generated that includes a 3:30 p.m. start time and second route. As another example, if user data indicates that a user may not arrive by the start time of a transportation segment, a contingency transportation segment can be generated that will deliver the user to the destination location in an acceptable amount of time. In such fashion, contingency transportation segment(s) can be selected for predicted (e.g., based on user data and/or aviation data) and/or unforeseen incidents that can render a transportation segment unviable. The contingency transportation segment(s) can be selected based on the reason that the transportation segment is being replaced.

In some implementations, a contingency segment can be generated based on aviation data. More particularly, a contingency segment can be generated in response to aviation data that indicates changes to an aviation service. As an example, aviation data can indicate that a flight service was delayed by 1 hour. In response, a contingency segment can be generated with a correspondingly delayed start time. This can include, for example, assigning the user to an aerial vehicle that leaves at a later time than the user's originally scheduled aerial transport leg of the user's multimodal transportation service. In such fashion, contingency segment(s) can be generated in response to aviation data that indicates a change to a previously scheduled service, allowing a multimodal transportation itinerary adjustment to be selected from the one or more prepared contingency segment(s).

In some implementations, a contingency segment can be selected for a multimodal transportation itinerary adjustment. The selection can, as an example, be performed by the operations computing system. For example, a contingency segment can be selected by the operations computing system based on a metric or an evaluation of multiple metrics (e.g., speed, efficiency, vehicles available, user satisfaction, etc.). In some implementations, the one or more contingencies can be presented to a user and the user can select a contingency segment. As an example, aviation data can indicate a 1-hour delay for a flight service scheduled for a user. The operations computing system can provide for display (e.g., by an associated application on a user computing device) contingency segments generated based on the 1-hour delay. The user can select (e.g., using a touch command, voice command, etc.) a desired contingency segment. This can include, for example, selecting a later departure time for the user's first transportation segment, a later flight departure time for the user's aerial transportation segment, etc. Information associated with the respective contingency segments can be provided to the user for display in conjunction with the contingency segment(s). As an example, three contingency segments can be presented to the user, each including a respective time of arrival, service cost, service cost reduction, mode of transportation, departure time, etc. In such fashion, the user can determine the most optimal contingency setting based on the user's own preferences.

In some implementations, the multimodal transportation service itinerary can be stored as a data structure that includes the transportation segment(s) of a multimodal transportation service in addition to other ancillary information (e.g., seating arrangements for an associated flight, luggage dimensions, etc.). User data can be included in the multimodal transportation service itinerary and/or associated with the multimodal transportation service itinerary (e.g., through a relational database association, etc.). The data structure can be stored in memory in a computing system associated with the multimodal transportation service provider (e.g., an operations computing system, etc.). Additionally, or alternatively, the multimodal transportation service itinerary can be stored in memory on a user device associated with the user (e.g., a smartphone, smart watch, laptop, etc.).

The one or more service actions can further include security process modification(s). Security process modification(s) can include adding security process(es) and/or removing security process(es). Security process(es) can include governmental security processes (e.g., background checks, TSA security checkpoints, no-fly lists, etc.), multimodal transportation service security processes (e.g., a security checkpoint at an associated VTOL vertiport, helipad, etc.), and/or flight facility security processes (e.g., additional, non-governmental security processes operated by the flight facility operator). Security process modification(s) can be based on user data and/or aviation data. As an example, user data can indicate that a user has undergone a security process (e.g., at a facility associated with the multimodal transportation service provider, etc.) that is sufficient to bypass additional governmental security process(es) and/or flight facility security process(es) (e.g., at an airport). Based on the user data, a security process modification can remove the governmental security process requirement, enabling the user to bypass security process(es) at the flight facility.

It should be noted that the addition or removal of security processes can, in some implementations, have an effect on the multimodal transportation service itinerary. As an example, the removal of a security process can make more time available for the delivery of the multimodal transportation service. If more time is made available, the multimodal transportation service itinerary can be modified in response (e.g., adjusting a start time, etc.). As another example, the addition of a security process can make less time available for the delivery of the multimodal transportation service. If less time is made available, the multimodal transportation service itinerary can be modified in response (e.g., changing a mode of transport from a slower autonomous vehicle to a faster VTOL craft, accelerating a start time, etc.).

The one or more service actions can further include user service optimization(s) for the multimodal transportation service or the aviation service(s). In some implementations, user service optimization(s) can include requesting one or more modifications to an airline service provided by an airline service provider. More particularly, the optimization(s) can include a request that the airline service provider modify a characteristic of an airline service offered to a user. As an example, the user service optimization may request that a flight facility operator prepare certain accessibility accommodations (e.g., wheelchairs, etc.) for an arriving user. As another example, the user service optimization may include a request that an airline operator provide vegetarian food offerings onboard a flight.

In some implementations, user service optimization(s) can include modifying a terminal map associated with a flight facility operator. The terminal map can be a representational mapping of the flight facility, as discussed previously. As an example, the user service optimization may modify the terminal map to highlight vegetarian food offerings based on historical user data indicating the user is a vegetarian (e.g., provided in a user's food deliver service profile associated with the multimodal transportation service provider). As another example, the user service optimization may modify the terminal map to highlight a closed section of the flight facility based on aviation data indicating that the section is undergoing maintenance. As yet another example, the user service optimization may modify the terminal map to highlight the most efficient route for the user to navigate towards a certain terminal based on aviation data indicating that the terminal services the users flight service (e.g., for a user with a short timeframe to board a flight, a user traveling with children, etc.). The terminal map can be modified in any manner that optimizes the delivery of service(s) to the user. The terminal map can, in some implementations, be communicated to a user device of the user for display. More particularly, the terminal map can be communicated by the operations computing system of the multimodal transportation service to the user device (e.g., to an associated application on the user device, etc.) that displays the map and associated modifications. As an example, the map can be communicated to a user smartphone that displays the modified map to the user.

In some implementations, the user service optimization(s) can include modifying a flight provided by an airline operator based on an aggregation of user data for a flight service. More particularly, the operations computing system can determine that a plurality of users are each scheduled for the same flight service based on an aggregation of user data from the respective users. The user service optimization(s) can modify certain aspects of the flight, such as departure times, arrival times, seating arrangements, etc. As an example, if a majority of passengers of a flight service are users of the transportation service provider, the user service optimization(s) may modify the departure time of a flight to leave fifteen minutes earlier than previously planned. As another example, the user service optimization(s) may modify the seating arrangements of the flight (e.g., to provide a user a window seat, to seat a late user towards the front of the flight vehicle, etc.). The flight modifications can, in some implementations, be communicated to a user device of the user for display. More particularly, the flight modifications can be communicated by the operations computing system of the multimodal transportation service to the user device (e.g., to an associated application on the user device, etc.) that displays information indicating the modifications made to the flight. As an example, a modified departure time can be communicated to a user smartphone that displays information indicating the modified departure time to the user.

In some implementations, the user service optimization(s) can include providing an offer from an airline service to a user device of the user for display. Airline service providers can provide offers to the operations computing system of the multimodal transportation service, which can then be provided to the user device of the user for display. An aviation service provider can provide offers related to any provided service (e.g., flight ticket discounts, food service discounts, terminal parking discounts, on-flight WiFi discounts). As an example, aviation data can indicate that a flight is overbooked. An airline service provider can offer to move the user to a different flight in return for a reduced ticket price. As another example, historical user data can indicate that the user prefers vegetarian food offerings. In response, a flight facility operator can offer a coupon for vegetarian-oriented restaurants located inside the flight facility. As yet another example, historical user data can indicate that a user typically utilizes in-flight WiFi services. In response, the airline operator can offer a coupon for purchasing in-flight WiFi services to the user.

The one or more service actions can be performed by the operations computing system of the multimodal transportation system. Performance of the service action(s) can include, for example, modifying a multimodal transportation service itinerary, requesting modifications from airline service provider(s), communicating information to a user device associated with a user, etc.

As described herein, a passenger can be scheduled for and/or offered a number of various aviation services (e.g., flight services, terminal transportation services, food offerings, etc.) In response to obtaining passenger data associated with the user, an aviation service provider can determine modifications to these services (e.g., changing a food offering based on passenger food preferences, etc.). More particularly, a computing system associated with aviation service provider(s) can obtain passenger data for one or more users of a multimodal transportation service provider. The passenger data can include one or more passenger characteristics associated with each user of the one or more users of the multimodal transportation service provider. In some implementations, passenger characteristics can include luggage measurement data. Luggage measurement data can describe the weight and dimensions of the piece(s) of luggage of user(s) of the multimodal transportation service. As an example, the luggage measurement data can indicate that a user is carrying a piece of luggage that weighs 45 pounds and is 21 inches wide, 21 inches high, and 14 inches deep. The luggage measurement data can, in some implementations, be collected at a transportation facility operated by or associated with the multimodal transportation provider (e.g., a VTOL vertiport, helipad, etc.).

In some implementations, the computing system of the aviation service provider can make a food purchasing determination for passenger(s). More particularly, the computing system can utilize the passenger status data to determine (e.g., using one or more algorithm(s), heuristic(s), machine-learned model(s), etc.) whether the passenger has recently purchased food (e.g., if the passenger purchased food at a transportation service facility, etc.). In response to this determination, the computing system can modify one or more characteristics of the aviation services offered. As an example, if a user is determined to have recently eaten, a flight service provider can reduce the amount of food loaded onto the airplane performing the user's flight service.

In some implementations, the one or more passenger characteristics can include historical data. Historical data can indicate historical user(s) preferences, statuses, and other historical user(s) behavior(s). As an example, historical data may indicate that user(s) is/are historically late or early when arriving at a terminal. As another example, historical data may indicate that user(s) generally prefer to utilize in-flight WiFi options. As yet another example, historical data may indicate that user(s) rarely consume food offerings offered onboard a flight service.

In some implementations, the one or more passenger characteristics can include security data. Security data can indicate a security clearance level associated with user(s). As an example, the security data can indicate that user(s) have undergone security procedure(s) (e.g., at a multimodal transportation service facility, etc.) of a sufficient security level to bypass governmental security checks (e.g., airport security checks, etc.) and/or aviation service provider(s) security checks. In such fashion, the airline service provider(s) can verify the security status of user(s) and allow user(s) to bypass security process(es) inside the flight facility.

In some implementations, the one or more passenger characteristics can include itinerary data. Itinerary data can indicate the travel itinerary of each user of the one or more users. The travel itinerary of the user(s) can indicate an arrival time, a current location, flight information, a mode of transportation, and/or any travel contingencies. As an example, the itinerary data may indicate that all user(s) of the multimodal transportation service will arrive by the departure time of the flight. As another example, the itinerary data may indicate that all user(s) of the multimodal transportation service are arriving in an aerial vehicle (e.g., VTOL craft, helicopter, etc.). As yet another example, the itinerary data may indicate that at least some user(s) will arrive after the departure time of the flight.

The computing system associated with aviation service provider(s) can determine, based on passenger data, one or more aviation services to be provided to at least one of the user(s) of the multimodal transportation service. More particularly, the aviation service(s) can identify the aviation service(s) that are scheduled to be and/or can be offered to the user(s) of the multimodal transportation service based on the user data. The one or more aviation services can be provided by a flight facility operator and/or an airline operator.

In some implementations, the aviation service(s) can include a flight service. The flight service can include one or more flight service characteristics. The flight service characteristic(s) can include any determinable aspect of the flight service to be offered, such as a passenger seating arrangement, on-board food offerings, a flight departure time, a flight fuel allocation, a flight luggage distribution, a flight vehicle used, a flight boarding time, etc. As an example, the flight service characteristic(s) for a certain flight can include a departure time of 3:00 pm, a boarding time of 2:35 p.m, a certain flight vehicle (e.g., a large passenger jet, etc.), and vegetarian food offerings.

In some implementations, the aviation service(s) can include a security process. The security process can include one or more security characteristics. The security characteristic(s) can indicate security process requirements and statuses. As an example, the security characteristic(s) may indicate that each passenger of a flight service is required to pass through an airline service mandated security procedure. As another example, the security characteristic(s) may indicate that passengers are not required to pass through a flight facility operator mandated security procedure or may indicate that passengers have already done so.

In some implementations, the aviation service(s) can include one or more flight facility travel services. The flight facility travel service(s) can include service(s) that provide transportation for passengers to, from, and around the flight facility (e.g., trams, shuttles, light rails, handicap pickup and drop-off, parking, etc.). The flight facility travel service(s) can include one or more travel service characteristics. The travel service characteristics can include and/or indicate departure times, arrival times, start locations, destination locations, and capabilities (e.g., handicap access, etc.) of the travel service(s) offered to passengers. As an example, travel service characteristic(s) may include a start time of 3:00 pm for a parking lot shuttle of the flight facility operator.

In some implementations, the aviation service(s) can include accommodations. Accommodations can include lodgings (hotels, motels, hostels, etc.) that are offered by or associated with aviation service provider(s). As an example, a flight facility may include a hotel. As another example, an airline service may be associated with a local hotel or motel. Accommodations can include accommodation characteristics, such as room selection, length of stay, room upgrades, room amenities, etc.

The computing system associated with the aviation service provider(s) can determine, based on passenger data, one or more aviation service modifications. The aviation service modification(s) can be configured to modify one or more service characteristics associated with at least one aviation service of the aviation service(s). More particularly, different characteristics of the aviation service(s) (e.g., flight services, accommodations, security processes, food services, travel services, etc.) can be modified based on the passenger data. As an example, the departure time of a flight service can be modified based on passenger data indicating passenger(s) of the flight service will be late. As another example, security process requirements can be modified (e.g., removed, etc.) based on passenger data indicating a passenger has been pre-cleared by another security process. As yet another example, travel service vehicles can be modified (e.g., replacing a scheduled shuttle with a handicap-accessible shuttle, etc.) based on passenger data indicating that a passenger is handicapped. As yet another example, a boarding order can be modified based on passenger data indicating that a passenger will arrive late or early. Accommodations, for example, can be modified (e.g., applying a room upgrade) based on user data indicating that certain users are frequent visitors of the flight facility. Luggage distribution in the plane, for example, can be modified based on the dimensions of user(s) luggage.

In some implementations, the one or more users of the multimodal transportation service provider can include a plurality of users. The computing system of the aviation service provider(s) can determine, based on the passenger data, one or more aviation services to be offered to the plurality of passengers. As an example, a flight service can be determined to have been scheduled for each passenger of the plurality of passengers. Based on the passenger data for each user of the plurality of users, one or more aviation service modifications can be determined. The aviation service modification(s) can be configured to modify service characteristic(s) associated with the aviation service, as discussed previously.

More particularly, if an aviation service is determined to be offered to each user of the multimodal transportation service, modification(s) can be applied based on the passenger data for each user. As an example, passenger data can indicate that each user of the multimodal transportation service will most likely arrive after the scheduled departure time of a flight service. In response, the departure time of the flight service can be modified so that the flight departs after all users arrive at the flight facility. As another example, passenger data can indicate that some passengers will arrive at different times than others. In response, the boarding order to board the flight vehicle can be modified to efficiently account for the arrival time of the passengers. In such fashion, the aviation service provider(s) can modify aviation service(s) based on a number of users and shared commonalities between users of a multimodal transportation service.

The one or more aviation service modifications can be performed by the computing system associated with the aviation service provider(s). Performance of the aviation service modifications(s) can include, for example, modifying aviation service characteristic(s) (e.g., modifying flight departure times, rescheduling flight facility travel services, etc.). The aviation service modification(s) can be communicated to at least one of the user(s) of the multimodal transportation service provider. More particularly, data indicating the modification(s) performed can be communicated (e.g., through an associated application, etc.) to a user device for display to the user. As an example, data indicating a modified departure time can be communicated to the device of a user and then displayed to the user.

Example aspects of the present disclosure can provide a number of improvements to multimodal transportation service systems. As an example, an operations computing system of a multimodal transportation service can obtain user data including one or more characteristics associated with the user. The operations computing system can further obtain aviation data for one or more aviation service providers (e.g., a flight facility operator or an airline operator). The aviation data can include aviation characteristics associated with the aviation service provider(s). Based on the user data and the aviation data, the operations computing system can determine and perform one or more service actions (e.g., adjust the user's transportation service itinerary, etc.). For example, user data and aviation data can indicate that a flight departure time has been delayed by two hours. In response, the operations computing system can delay the start time of the first segment of the user's multimodal transportation service itinerary. Thus, the computer-implemented techniques disclosed herein result in substantially improved delivery of services to a user, improved route planning, dynamic modification of transportation services, improved utilization of transportation vehicles (e.g., autonomous vehicles, VTOL craft, etc.) and other benefits and improvements.

improvements.

With reference to the figures, example embodiments of the present disclosure will be discussed in further detail.

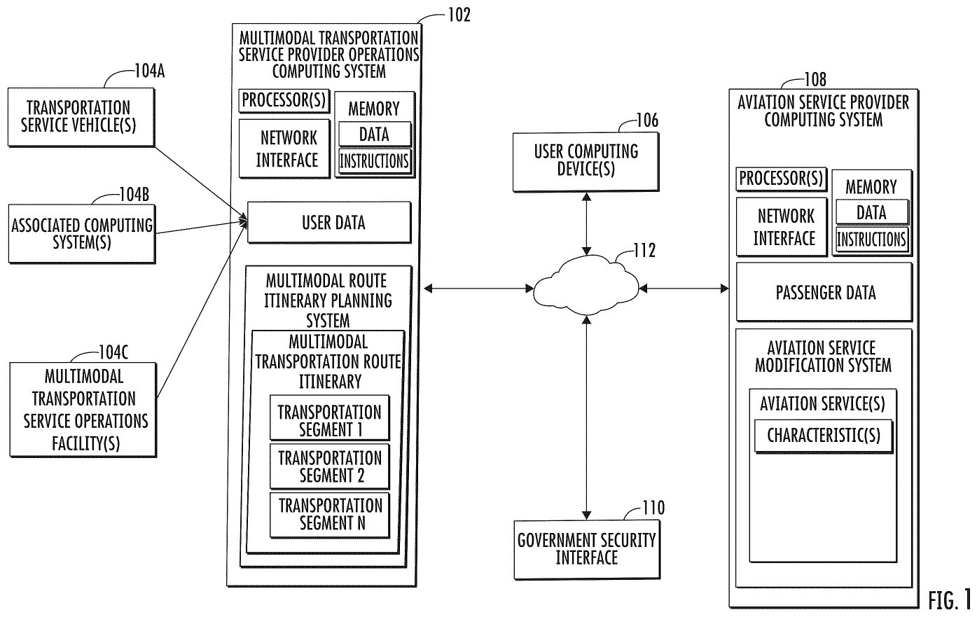

FIG. 1 depicts an example infrastructure system for multimodal transportation service optimization and aviation service optimization according to example embodiments of the present disclosure. More particularly, the multimodal transportation service provider can utilize an operations computing system 102. The operations computing system 102, as depicted, can include processor(s), network interface(s), one or more memories including data and instructions, etc. It should be noted that the operations computing system 102 can function in a distribution fashion (e.g., across a plurality of computing systems and or devices, etc.). Operation in such fashion can be facilitated across a network (e.g., network 112) using application programming interface(s).

The operations computing system 102 can obtain and/or include (e.g., in one or more memories, etc.) user data. User data can be obtained from transportation service vehicles 104A (e.g., aerial autonomous vehicles, ground-based autonomous vehicles, etc.). As an example, a ground-based autonomous vehicle 104A can automatically obtain user luggage weight data with weight sensors in the vehicle. User data can also be obtained from associated computing system(s) 104B (e.g., remote databases, etc.). As an example, historical user preference data can be stored in associated computing system(s) 104B and can later be obtained by the operations computing system 102. User data can also be obtained from associated multimodal transportation service operation facilities 104C. As an example, the multimodal transportation service operation facilities 104C (e.g., vertiports, heliports, etc.) can obtain user security data (e.g., through a security procedure in a vertiport facility) that allows a user to bypass a further security procedure (e.g., a TSA security procedure, etc.).

User data can include user characteristics associated with user(s) of the multimodal transportation service. In some implementations, the one or more user characteristics can include user security data. User security data can, in some implementations, be obtained at a transportation facility associated with the multimodal transportation service provider (e.g., a VTOL vertiport, etc.) and/or in association with governmental security services (e.g., the Transportation Security Administration, etc.). The user security data can indicate a security clearance level associated with the user. As an example, the user security data can indicate that a user has undergone security procedure(s) (e.g., at a multimodal transportation service facility, etc.) of a sufficient security level to bypass subsequent governmental security checks (e.g., airport security checks, etc.). programming interfaces) to determine if a user can bypass one or more governmental security processes.

More particularly, the operations computing system 102 can communicatively interface with a government security interface 110 (e.g., API, etc.) via a network 112 to facilitate the security authorization of user(s) of the multimodal transportation service. As an example, the operations computing system 102 can communicate user data to the government security interface 110. The operations computing system 102 can then receive data from the government security interface 110 that associates a certain level of security authorization with the user. For example, the government security interface 110 can, based on data associated with security process(es) already undergone by the associated user, authorize the user to directly bypass transportation security administration security processes that are otherwise mandatory.

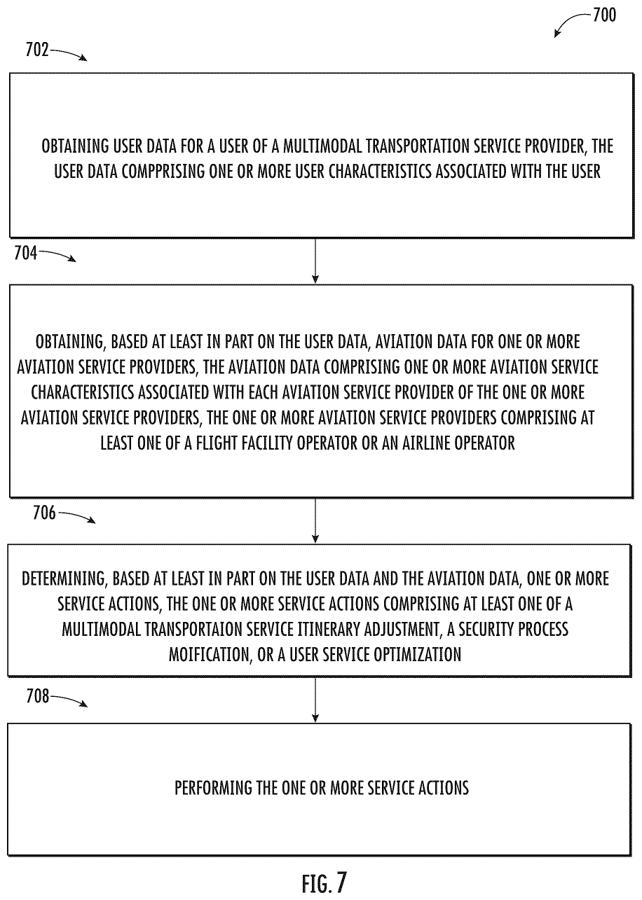

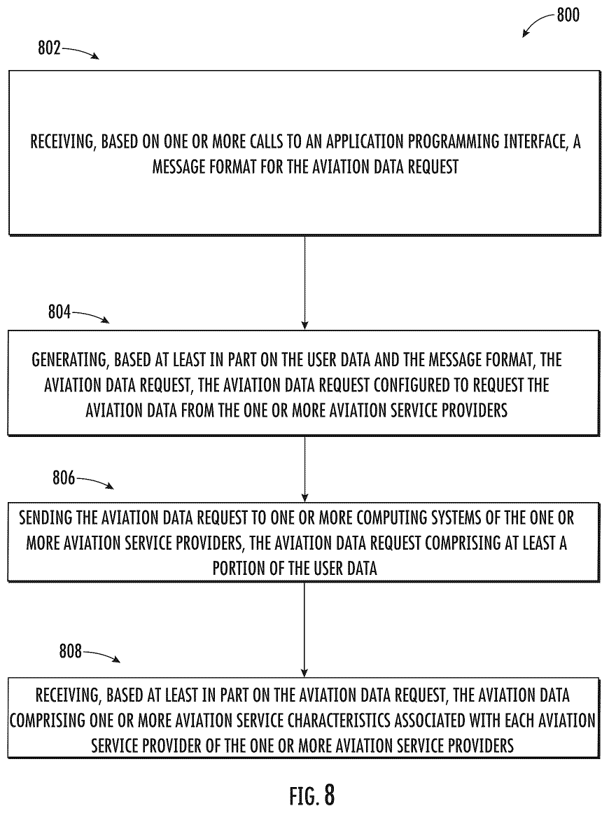

User data can, in some implementations, be obtained through communication with user computing device(s) 106 via network(s) 112. As an example, a user computing device 106 can indicate (e.g., through GPS, etc.) that a user has arrived at a certain destination. As another example, the user device may contain user preference data, historical user data, or other relevant data that can be obtained by the operations computing system 102. User data will be discussed in greater detail with regards to FIG. 7.

The operations computing system 102 of the multimodal transportation service provider can communicate with the computing system of one or more aviation service providers 108 via network(s) 112 (e.g., using one or more application programming interfaces, etc.). It should be noted that the computing system 108 can be associated with any number of aviation service providers. As an example, the computing system 108 can be associated with a single flight facility operator. As another example, the computing system 108 can be associated with a flight facility operator and every airline service provider that operates out of the associated flight facility. As yet another example, the computing system 108 can be associated with a single airline service provider. By communicating with aviation service provider computing system 108, the operations computing system 102 can obtain aviation data for the airline service provider. Aviation service providers can include airline operator(s) (e.g., regional and/or national airlines, etc.), flight facility operators (e.g., airport operators, vertiport operators, etc.), and/or other types of aviation service providers.

In some implementations, aviation data can be obtained by generating an aviation data request based at least in part on the user data. The aviation data request can be configured to request the aviation data from the computing system 108 of aviation data service provider(s). As an example, the operations computing system 102 can, in some implementations, receive a message format for the aviation data request (e.g., a particular Javascript Object Notation format, HTTP method, verification key, etc.) based on one or more calls to an application programming interface associated with the computing system 108 of the airline service provider(s). The operations computing system 102 can generate and send an aviation data request based on the user data and the message format. The aviation data request can be configured to request the aviation data from the aviation service provider(s) computing system 108 based at least in part on the user data and by including at least a portion of the user data in the request. The aviation data can be received by the operations computing system 102 of the multimodal transportation service provider in response to the aviation data request. Communication of these messages can be facilitated by network(s) 112.

In general, communication over the network 112 can be implemented via any type of wired or wireless connection, using a wide variety of communication protocols, encodings or formats, and/or protection schemes. Example communication technologies used in accordance with example aspects of the present disclosure can include, for instance, Wi-Fi (e.g., IEEE, 802.11), Wi-Fi Direct (for peer-to-peer communication), cellular communication, LTE, low-power wide area networking, VSAT, Ethernet, etc. Other suitable wired and/or wireless communication technologies can be used without deviating from the scope of the present disclosure.

The operations computing system 102 can generate a multimodal transportation itinerary for the user using the multimodal route itinerary planning system. A multimodal transportation service itinerary can include two or more transportation segments. A transportation segment can include a start time, an end time, a start location, a destination location, and a mode of transportation to implement the transportation segment. As an example, a first transportation segment can include ground-based transportation (e.g., via a human driven car), a start time of 3:00 p.m., a start location of a user's residence, an end time of 3:45 p.m., and a destination location of an aerial transportation facility (e.g., a vertiport, a helipad, etc.) associated with the multimodal transportation service provider. Transportation segments can be added and/or removed from the multimodal transportation service itinerary, and can be implemented by utilizing any sort of autonomous or non-autonomous transportation vehicle (e.g., ground-based vehicle, aerial vehicle, water-based vehicle, etc.).

The operations computing system 102 of the multimodal transportation service can determine one or more service actions to perform based on the user data and the aviation data. Service action(s) can be performed by the multimodal route itinerary planning system of the operations computing system 102, and can include multimodal transportation service itinerary adjustment(s). As an example, an itinerary adjustment may adjust a start time for a transportation segment from 3:15 p.m. to 3:45 p.m. because the user status data includes a user location that indicates the user will not arrive to the start location on time.

According to another aspect of the present disclosure, the aviation service provider(s) can utilize an aviation service provider computing system 108 as depicted in FIG. 1. The aviation service provider computing system 108, as depicted, can include processor(s), network interface(s), one or more memories including data and instructions, etc. It should be noted that the aviation service provider computing system 108 can function in a distribution fashion (e.g., across a plurality of computing systems and or devices, etc.). Operation in such fashion can be facilitated across a network (e.g., network 112) using application programming interface(s).

The aviation service provider computing system 108 can obtain and/or include (e.g., in one or more memories, etc.) passenger data. In some implementations, passenger data can include one or more passenger characteristics (e.g., luggage measurement data, historical data, security data, itinerary data, etc.). Passenger data can be obtained from users of the multimodal transportation service provider. More particularly, passenger data can be obtained from the multimodal transportation service provider operations computing system 102 via a network 112. The passenger data can include at least some of the user data included in the operations computing system 102. As an example, a multimodal transportation service operations facility 104C (e.g., a vertiport, heliport, etc.) can measure a passenger's luggage (e.g., weight, dimensions, etc.) to obtain luggage measurement data. Luggage measurement data can be stored in and/or by the operations computer 102, and can be provided to the aviation service provider computing system 108 via the network 112. In such fashion, passenger data, at least in part, can be obtained from the operations computing system 102 by the computing system 108.

The aviation service provider computing system 108 can, in some implementations, send data to the operations computing system 102 of the multimodal transportation service provider via network 112. As an example, the aviation service provider computing system 108 can send mapping data of a flight facility to the operations computing system 112. Flight facility operator mapping data can include a mapped representation of a flight facility. The mapping data can represent the flight facility using any preferred perspective, dimensionality, and/or level of interactivity. As an example, the mapping data can include a static, top-down, two-dimensional representation of a flight facility and the various services (e.g., restaurants, terminals, family friendly bathrooms, etc.) offered inside and/or around the flight facility.

The mapping data sent to the multimodal transportation service provider's operations computing system 102 can, in some implementations, be sent to user device(s) via network 112. More particularly, the mapping data can be sent to an application on user device(s) that is associated with the multimodal transportation service provider. The mapping data can, in some implementations, be modified by the operations computing system 102 based on the user data before being sent to the user computing device(s). As an example, user data may indicate that the user prefers vegetarian options. The mapping data can be modified to highlight the vegetarian food offerings provided by the flight facility operator, as further described herein. These specific offerings, and other locations and/or services of interest, can be included in the mapping data when sent to the operations computing system 102 by the aviation service provider computing system 108

The aviation service provider computing system 108 can determine one or more aviation services to be provided to one or more passengers based on the passenger data. Characteristics of the aviation service(s) can be modified by the aviation service modification system. As an example, the aviation service modification system can be used to modify the food products offered on a flight service of an airline service provider, as further described herein.

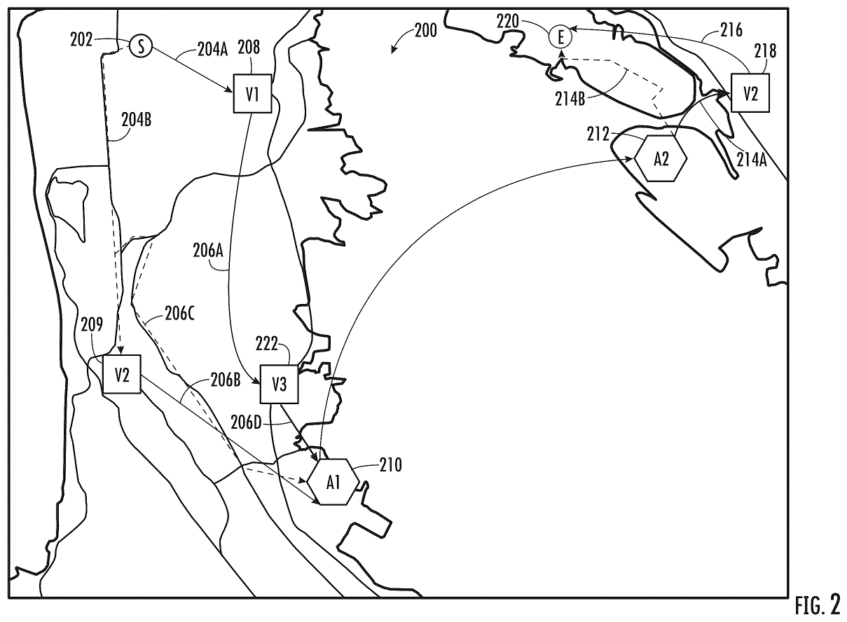

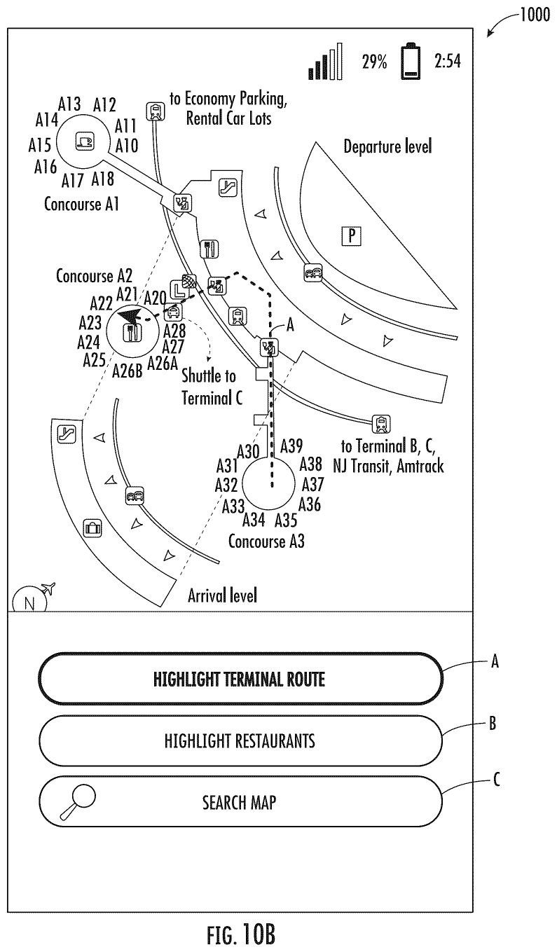

FIG. 2 depicts an example transportation segments and contingency transportation segments of a multimodal transportation service itinerary according to example embodiments of the present disclosure. The example transportation segments and/or contingency segments can be generated and/or modified by the operations computing system of the multimodal transportation service provider. Further, the segments can be displayed to a user device of a user and can be selected and/or modified based on user input, as will be discussed in greater detail with regards to FIG. 10A.

As depicted, a multimodal transportation service itinerary can include an origin location 202 (e.g., a “start” location, etc.), a destination location 220 (e.g., an “end” location), one or more service facilities (e.g., V1, V2, V3, V4, A1, A2, etc.) and one or more transportation and/or contingency transportation segments (e.g., 204, 206, 216, etc.). In some implementations, the multimodal itinerary can be a three-leg multi-modal itinerary. As an example, the origin location 202 can be connected to a transportation facility 208 (e.g., a first vertiport of the multimodal transportation service itinerary) by transportation segment 204A. Transportation segment 204A can, for example, be serviced for the user by a service vehicle of the multimodal transportation service (e.g., a ground-based autonomous rideshare vehicle, a manually operated rideshare vehicle, etc.). In some implementations, the user can be transported from the transportation facility 208 (e.g., the first vertiport, helipad, etc. of the transportation service) to another, second transportation facility 226 (e.g., a second vertiport, helipad, etc. of the transportation service) via transportation segment 206A. Transportation segment 206A can be serviced, for example, by an aerial service vehicle of the multimodal transportation service provider (e.g., a VTOL craft, a helicopter, etc.). The user can be transported from the transportation facility 226 to a flight facility 210 via transportation segment 206D. Transportation segment 206A can be serviced, for example, by a service vehicle (e.g., ground-based vehicle, bicycle, scooter, shuttle, etc.) or by the user walking to the flight facility 210.

In some implementations, the multimodal transportation service itinerary can be a two-leg multi-modal itinerary. As an example, the origin location 202 can be connected to a transportation facility 208 by transportation segment 204A. The user can be transported from the transportation facility 208 to a flight facility 210 via transportation segment 206A, which can extend from the transportation facility 208 to the flight facility. Transportation segment 206A can be serviced, for example, by an aerial service vehicle of the multimodal transportation service provider. As further described herein, the landing location of the aerial service vehicle can be one or more locations associated with the flight facility (e.g., prior to a security screening area, beyond a security screening area, etc.).

Alternatively, the origin location 202 can be connected to another, third transportation facility 209 (e.g., a third vertiport of the transportation service provider) by a contingency transportation segment 204B. Contingency segments can be selected by a multimodal transportation service itinerary adjustment for numerous reasons, including a user request, a scheduled user flight service delay, user preferences, and any other reason that can provide an optimization to the user and/or the multimodal transportation service provider. If the multimodal transportation service itinerary is adjusted by a service action (e.g., in response to a delay at transportation facility 208, a flight service delay at flight facility 210, etc.), a contingency segment 204B can be selected to transport the user from the origin location 202 to the transportation facility 209. The user can be transported from the transportation facility 209 to the flight facility 210 via transportation segment 206B (e.g., serviced by a VTOL craft, helicopter, etc.). Alternatively, a contingency route 206C can be selected to transport the user from transportation facility 209 to flight facility 210. The contingency route can be selected for a number of reasons (e.g., the transportation facility is overbooked, the user prefers the mode of transportation of segment 206C, the users flight service is delayed, etc.).

The user can be transported from the flight facility 210 to the flight facility 212 via a flight service offered by an airline operator. In some implementations, the flight service offered by the airline operator can be distinct from the transportation segments of the multimodal transportation service itinerary. By way of example, the multimodal transportation service itinerary would offer transportation segment(s) for transportation to a flight facility and from a reciprocal flight facility. More particularly, the flight service between flight facilities (e.g., a higher altitude commercial airline flight) itself would not be included in the multimodal transportation service itinerary, although relevant information associated with the flight service (e.g., flight facility location(s), departure time, arrival time, etc.) can be included in the multimodal transportation service itinerary and/or other data structures associated with the multimodal transportation service provider

In some implementations, the multimodal transportation service provider can collaboratively include the flight service of the airline service provider in the multimodal transportation service itinerary. This inclusion can be accomplished through communication (e.g., application integration, API(s), etc.) between the service providers. As an example, a user can request a transportation service from the user's residence in New York to a location in San Francisco through an application (e.g., on a user smartphone device, etc.) associated with the multimodal transportation service provider. The multimodal transportation service provider can communicate the request to the airline service provider through an established communication channel (e.g., application programming interface(s), etc.) to automatically purchase a flight service for the user that can be included in the multimodal transportation service itinerary. Thus, in such fashion, the multimodal transportation service itinerary can include every transportation segment (e.g., ground-based, aerial-based, flight services, etc.) necessary to transport a user to a desired destination.

The multimodal transportation service itinerary can include transportation segments from a reciprocal flight facility 212 to a destination location 220. As depicted, the user can be transported to transportation facility 218 (e.g., fourth vertiport, helipad, etc.) via transportation segment 214A. The user can subsequently be transported from transportation facility 218 to destination location 220 via transportation segment 216 (e.g., serviced by helicopter, VTOL craft, etc.). Alternatively, as depicted, contingency segment 214B can be selected to transport the user from flight facility 212 to destination location 220. Contingency segment 214B can be selected, for example, based on a multimodal transportation itinerary adjustment (e.g., in response to a delay at flight facility 218, user preferences, air traffic associated with segment 216, etc.).

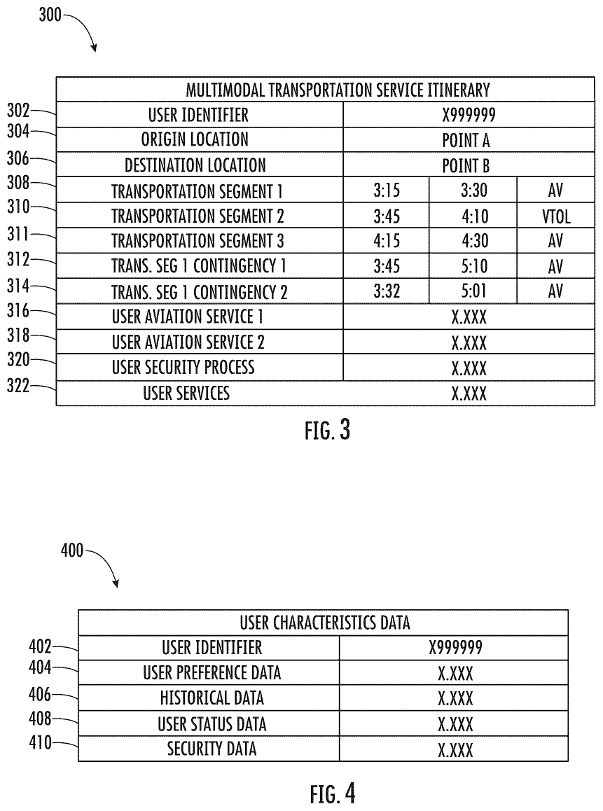

FIG. 3 depicts an example multimodal transportation service itinerary 300 according to example embodiments of the present disclosure. The multimodal transportation itinerary 300 can be generated, for example, by an operations computing system of the multimodal transportation service provider. The multimodal transportation itinerary can, in some implementations, be stored in the operations computing system, one or more remote computing devices associated with the multimodal transportation service provider, and/or user computing device(s) associated with the user that the multimodal transportation service itinerary was generated for.

In some implementations, the multimodal transportation service itinerary 300 can include a user identifier 302. The user identifier 302 can be a discrete string of numbers and/or characters associated with a user of the multimodal transportation service. In some implementations, if the user has utilized the multimodal transportation service previously, the user identifier can be retrieved from one or more databases associated with the multimodal transportation service provider.

The multimodal transportation service itinerary 300 can include an origin location 304 and a destination location 306. The locations 304 and 306 can be location names (e.g., a city name, a building name, etc.), geolocational coordinates (e.g., GPS coordinates, etc.), and/or any other form of location information sufficient to enable the transportation of the user. The origin location 304 and the destination location 306 can be connected via one or more transportation segments. As depicted, transportation segment 308 and transportation segment 310 are utilized to transport the user from the origin location 304 to the destination location 306. The transportation segments (e.g., 308 and 310) can include a departure time, an arrival time, and a mode of transportation. As an example, transportation segment 308 has an associated departure time of 3:15, an arrival time of 3:30, and a ground-based autonomous vehicle mode of transportation. Similarly, transportation segment 310 has a departure time of 3:45, an arrival time of 4:10, and a VTOL mode of transportation. Finally, transportation segment 311 has an associated departure time of 4:15, an associated arrival time of 4:30, and a ground-based autonomous vehicle mode of transportation.

In some implementations, one or more contingency transportation segments (e.g., 312 and 314) can be selected to replace one or more of the transportation segments (e.g., 308 and 310). Selection of contingency transportation segments can occur for a number of reasons, as described with regards to FIG. 2. As depicted, the contingency transportation segments can, in some implementations, be included in the multimodal transportation service itinerary, and can be utilized to replace a transportation segment by a multimodal transportation service itinerary adjustment. However, in some implementations, the contingency transportation segments do not necessarily need to be included in the multimodal transportation service itinerary. As an example, if transportation segment 310 is deemed unusable, a contingency transportation segment can be dynamically generated by the operations computing system to replace the transportation segment 310.

In some implementations, the multimodal transportation service itinerary 300 can also include services (e.g., 316-322). For example, services can include aviation services scheduled to be provided to the user such as aviation service 316 and aviation service 318 (e.g., flight services from an airline service provider, food offerings from a flight facility operator, etc.). Additionally, or alternatively, in some implementations, the services can include user security process(es) 320. User security process 320 can indicate a level of security that the user currently possesses (e.g., if a user has already been subject to a security process, etc.). In addition, the security process can indicate whether the user is scheduled to undergo additional security process(es) (e.g., TSA security checkpoints, flight facility operator checkpoints, etc.). Thus, in such fashion, the multimodal transportation service itinerary can minimize the security process(es) a user is required to undergo.

In some implementations, the services can include user services 322. User services 322 can include services to be provided to the user of the multimodal transportation service itinerary 300 outside the scope of transportation. Services scheduled for or already provided to the user can, in some implementations, be retrieved based on data stored and associated with the user identifier 302. As an example, the user services 322 may include food offerings for a user at a transportation facility of the multimodal transportation service provider (e.g., a VTOL vertiport, etc.). It should be noted that services 316-322 are depicted to illustrate the capability of the multimodal transportation service itinerary to include multiple types of data associated with the user. However, as discussed previously, the services 316-322 do not necessarily need to be included in the multimodal transportation service itinerary 300.

FIG. 4 depicts an example of user characteristics data 400 according to example embodiments of the present disclosure. In some implementations, the user characteristics data 400 can include a user identifier 402. The user identifier 402 can be a discrete string of numbers and/or characters associated with a user of the multimodal transportation service. In some implementations, if the user has utilized the multimodal transportation service previously, the user identifier can be retrieved from one or more databases associated with the multimodal transportation service provider. In some implementations, the user characteristics data 400 can include user preference data 404. User preference data 404 can indicate user preferences, such as preferred dietary choices (e.g., vegetarian options, etc.), flight seating arrangements (e.g., a preference for window seats), and any other preference(s) associated with services provided by the multimodal transportation service and/or the aviation service provider(s). As an example, user preference data 404 can indicate that a user prefers an aisle seat with a certain amount of legroom. As another example, user preference data 404 can indicate that a passenger prefers certain amenities associated with a flight service (e.g., food offerings, drink offerings, entertainment offerings, etc.).

In some implementations, the user characteristics data 400 can include user historical data 406. Historical user data 406 can indicate historical user preferences, statuses, and/or other historical user behavior(s) associated with the user's previous utilization of the multimodal transportation service. As an example, historical user data 406 may indicate that a user is historically late or early when utilizing the multimodal transportation service. As another example, historical user data 406 may indicate that a user generally prefers or avoids one or more modes of transportation (e.g., autonomous ground-based vehicles, aerial vehicles, etc.). As yet another example, historical user data 406 may indicate that the user prefers or avoids certain types of foods (e.g., dietary preferences, etc.). It should be noted that, in some implementations, the collection and/or generation of historical user data 406 by the multimodal transportation service provider can be opted out of by the user. In some other implementations, the collection and/or generation of historical user data 406 cannot occur without obtaining explicit permission from a user (e.g., through an application associated with the multimodal transportation service, etc.).

In some implementations, the user characteristics data 400 can include user status data 408. User status data 408 can indicate user information, user luggage weight, user location, person(s) associated with the user, and any other sort of information describing current aspect(s) of the user. As an example, user status data 408 can include user accommodations/information (e.g., medical conditions, disabilities, height, weight, etc.). As another example, user status data 408 can include the location of the user (e.g., along the multimodal transportation route). The user status data 408 can, for example, indicate one or more persons associated with the user (e.g., friends, family members, etc.).

In some implementations, the user characteristics data 400 can include user security data 410. User security data 410 can, in some implementations, be obtained at a transportation facility associated with the multimodal transportation service provider (e.g., a VTOL vertiport, etc.) and/or in association with governmental security services (e.g., the Transportation Security Administration, etc.). The user security data 410 can indicate a security clearance level associated with the user. As an example, the user security data 410 can indicate that a user has undergone security procedure(s) (e.g., at a multimodal transportation service facility, etc.) of a sufficient security level to bypass subsequent governmental security checks (e.g., airport security checks, etc.). In such fashion, the user security data 410 can be utilized to eliminate redundant security process(es) of the multimodal transportation service provider and/or the aviation service provider(s).

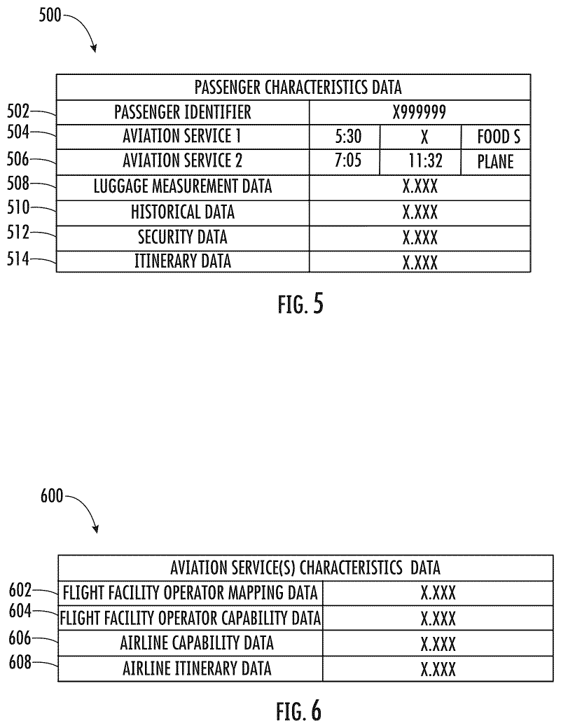

FIG. 5 depicts an example of passenger characteristics data 500 according to example embodiments of the present disclosure. In some implementations, the passenger characteristics data 500 can include a passenger identifier 502. The passenger identifier 502 can be a discrete string of numbers and/or characters associated with a passenger of one or more aviation service provider(s). In some implementations, if the passenger has utilized one or more aviation service provider(s) previously, the passenger identifier can be retrieved from one or more databases associated with the one or more aviation service provider(s).

In some implementations, the passenger characteristics data 500 can include aviation service(s) scheduled to be provided to the passenger. As depicted, aviation service(s) 504 and 506 are scheduled to be provided to a user. Aviation service(s) (e.g., flight services, terminal transportation services, food offerings, etc.) can be modified in response to passenger data associated with the passenger 502, which in some implementations can be obtained from a multimodal transportation service provider. As an example, aviation service 504 can be a food offering for a passenger. Based on passenger data that indicates the passenger is a vegetarian, the food offering service 504 can be modified to include vegetarian offerings.

In some implementations, the passenger characteristics data 500 can include luggage measurement data 508. Luggage measurement data 508 can describe the weight and dimensions of the piece(s) of luggage of user(s) of the multimodal transportation service. As an example, the luggage measurement data 508 can indicate that a user is carrying a piece of luggage that weighs 45 pounds and is 21 inches wide, 21 inches high, and 14 inches deep. The luggage measurement data 508 can, in some implementations, be collected at a transportation facility operated by or associated with the multimodal transportation provider (e.g., a VTOL vertiport, helipad, etc.). Based on the luggage measurement data 508, an aviation service provider can modify an aviation service provided to the passenger. As an example, an airline service provider can modify the luggage packing order of a plane associated with aviation service 506 based on the luggage measurement data 508.

In some implementations, the passenger characteristics data 500 can include historical data 510. Historical data 510 can indicate historical user(s) (e.g., users of a multimodal transportation service that are now passengers of the aviation service(s)) preferences, statuses, and other historical user(s) behavior(s). As an example, historical data 510 may indicate that user(s) is/are historically late or early when arriving at a terminal. As another example, historical data 510 may indicate that user(s) generally prefer to utilize in-flight WiFi options. As yet another example, historical data 510 may indicate that user(s) rarely consume food offerings offered onboard a flight service.

In some implementations, the passenger characteristics data 500 can include security data 512. Security data 512 can indicate a security clearance level associated with user(s). As an example, the security data 512 can indicate that user(s) have undergone security procedure(s) (e.g., at a multimodal transportation service facility, etc.) of a sufficient security level to bypass governmental security checks (e.g., airport security checks, etc.) and/or aviation service provider(s) security checks. In such fashion, the airline service provider(s) can verify the security status of user(s) and allow user(s) to bypass security process(es) inside the flight facility. In some implementations, the security data 512 can be indicative of whether the user has passed/gain certain security clearances (e.g., TSA Precheck™, etc.).

In some implementations, the passenger characteristics data 500 can include itinerary data 514. Itinerary data 514 can indicate the travel itinerary of a passenger. The travel itinerary 514 of the passenger can indicate an arrival time, a current location, flight information, a mode of transportation, and/or any travel contingencies. As an example, the itinerary data 514 may indicate that a passenger of the multimodal transportation service will arrive by the departure time of the flight. As another example, the itinerary data 514 may indicate that a passenger of the multimodal transportation service is arriving in an aerial vehicle (e.g., VTOL craft, helicopter, etc.). As yet another example, the itinerary data 514 may indicate that at least some passenger(s) will arrive after the departure time of the flight. In some implementations, itinerary data 514 can be collected for a plurality of passengers.

FIG. 6 depicts an example of aviation service(s) characteristics data 600 according to example embodiments of the present disclosure. In some implementations, the aviation service(s) characteristics data 600 includes flight facility operator mapping data 602. Flight facility operator mapping data 602 can include a mapped representation of a flight facility. The flight facility operator mapping data 602 can represent the flight facility using any preferred perspective, dimensionality, and/or level of interactivity. As an example, the flight facility operator mapping data 602 can include a static, top-down, two-dimensional representation of a flight facility and the various services (e.g., restaurants, terminals, family friendly bathrooms, etc.) offered inside and/or around the flight facility. As another example, the flight facility operator mapping data 602 can include a two-dimensional or three-dimensional, interactive representation of the flight facility that can be modified (e.g., highlighting the location of a service, etc.) based on received inputs (e.g., a user input, etc.). As yet another example, the flight facility operator mapping data 602 can include a virtual reconstruction of the flight facility that is navigable from a user computing device (e.g., a virtual “tour” of the flight facility, etc.).

In some implementations, the flight facility operator mapping data 602 can more particularly include additional information regarding the service(s) provided by the flight facility operator. As an example, the flight facility operator mapping data 602 can include menus for restaurants located in the flight facility and/or products offered in various shops located in the flight facility. In some implementations, the flight facility operator mapping data can be provided to a user device for display to the user in an interactive manner. The user can interact with the displayed mapping data to communicate service requests to the multimodal transportation service provider (e.g., through an associated application, etc.) and/or service providers associated with the multimodal transportation service provider (e.g., food ordering services, autonomous food delivery services, etc.). As an example, if flight facility operator mapping data 602 provided for display to the user includes a menu for a restaurant located in the flight terminal, the user can interact with the menu to request food be prepared in advance for the user. The user request can be received by the multimodal transportation service provider and, in some implementations, can be communicated to the flight facility operator and/or associated service provider(s) (e.g., restaurants, shops, etc.).

In some implementations, the aviation service(s) characteristics data 600 can include flight facility operator capability data 604 that describes one or more capabilities of the flight facility operator. Flight facility operator capability data 604 can include flight facility transportation services (e.g., trams, shuttles, taxis, terminal parking, etc.), handicap accessibility (e.g., wheelchair ramps, medical accommodations, etc.), food offerings (e.g., vegetarian options, allergen-free options, etc.), offered services (e.g., travel agents, currency exchanges, customer services, etc.), or any other capabilities of the flight facility operator. As an example, the flight facility operator capability data 604 can indicate that a flight facility does possesses the accessibility infrastructure necessary to service a quadriplegic user. As another example, the flight facility operator capability data 604 can indicate that a flight facility operator provides multiple food offerings for users with severe nut allergies. In addition, the flight facility operator capability data 604 can indicate whether a flight facility allows for direct air transportation of users. As an example, the flight facility operator capability data 604 can indicate that an aerial vehicle of the multimodal transportation service (e.g., a helicopter, a VTOL craft, etc.) can land in or on an area of the flight facility (potentially beyond a security checkpoint).

In some implementations, the aviation service(s) characteristics data 600 can include airline capability data 606. Airline capability data 606 can describe the capabilities of the airline operator in a substantially similar fashion as the flight facility operator capability data 604, as discussed above. Further, the airline capability data 606 can indicate specific capabilities of the flight services of the airline operator (e.g., in-flight entertainment offerings, seats with more leg room, first class upgrades, etc.). For example, the airline capability data 606 may indicate that a flight service of the airline operator has food offerings for passengers with certain food restrictions, or that a flight service is wheelchair accessible. In addition, the airline capability data 606 can indicate whether the airline permits users to disembark an aerial vehicle of a multimodal transportation service and directly board a flight service of the airline operator.

In some implementations, the aviation service characteristic(s) data 600 can include airline itinerary data 608. Airline itinerary data 608 can describe a departure time, departure location, arrival time, and/or arrival location of a flight service provided by the airline operator. The airline itinerary data 608 can also describe any modifications to the aforementioned aspects of the flight service. As an example, the airline itinerary data 608 can indicate that a flight service has a departure time of 3:00 pm at a terminal 15 of a flight facility. As another example, the airline itinerary data 608 can indicate that the flight service departure time has been modified to 3:45 p.m. In such fashion, the aviation service characteristics data 600 can indicate any changes or modifications (e.g., delays, early arrivals, etc.) to aviation service(s) offered to the user.

FIG. 7 depicts a flowchart diagram of an example method of optimizing multimodal transportation services according to example embodiments of the present disclosure. One or more portion(s) of the operations of method 700 can be implemented by one or more computing systems that include, for example, one or more portions of an operations computing system (e.g., operations computing system 102, etc.). Each respective portion of the method 700 can be performed by any (or any combination) of the computing device(s) of the respective computing system. Moreover, one or more portion(s) of the method 700 can be implemented as an algorithm on the hardware components of the device(s) described herein, for example, to facilitate optimization of services provided to user(s). FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 702, the method 700 can include obtaining user data for a user of a multimodal transportation service provider. User data can be obtained from a user device associated with the user, computing system(s) associated with the multimodal transportation service provider, transportation vehicles and/or facilities associated with the multimodal transportation service provider, food delivery services associated with the multimodal transportation service provider, etc. The user data can include one or more user characteristics associated with the user.

In some implementations, the one or more user characteristics can include historical user data. Historical user data can indicate historical user preferences, statuses, and/or other historical user behavior(s) associated with the user's previous utilization of the multimodal transportation service. As an example, historical user data may indicate that a user is historically late or early when utilizing the multimodal transportation service. As another example, historical user data may indicate that a user generally prefers or avoids one or more modes of transportation (e.g., autonomous ground-based vehicles, aerial vehicles, etc.). As yet another example, historical user data may indicate that the user prefers or avoids certain types of foods (e.g., dietary preferences, etc.). It should be noted that, in some implementations, the collection and/or generation of historical user data by the multimodal transportation service provider can be opted out of by the user. In other implementations, the collection and/or generation of historical user data cannot occur without obtaining explicit permission from a user (e.g., through an application associated with the multimodal transportation service, etc.).

In some implementations, the one or more user characteristics can include user status data. User status data can indicate user information, user luggage weight, user location, person(s) associated with the user, and any other sort of information describing current aspect(s) of the user. As an example, user status data can include user accommodations/information (e.g., medical conditions, disabilities, height, weight, etc.). As another example, user status data can include the location of the user (e.g., along the multimodal transportation route). The user status data can, for example, indicate one or more persons associated with the user (e.g., friends, family members, etc.).

In some implementations, the one or more user characteristics can include user security data. User security data can, in some implementations, be obtained at a transportation facility associated with the multimodal transportation service provider (e.g., a VTOL vertiport, etc.) and/or in association with governmental security services (e.g., the Transportation Security Administration, etc.). The user security data can indicate a security clearance level associated with the user. As an example, the user security data can indicate that a user has undergone security procedure(s) (e.g., at a multimodal transportation service facility, etc.) of a sufficient security level to bypass subsequent governmental security checks (e.g., airport security checks, etc.). In such fashion, the user security data can be utilized to eliminate redundant security process(es) of the multimodal transportation service provider and/or the aviation service provider(s).

In some implementations, the one or more user characteristics can include user preference data. User preference data can be provided by the respective user and/or obtained from historical user data. User preference data can indicate user preferences, such as preferred dietary choices (e.g., vegetarian options, etc.), flight seating arrangements (e.g., a preference for window seats), and any other preference(s) associated with services provided by the multimodal transportation service and/or the aviation service provider(s). As an example, user preference data can indicate that a user prefers an aisle seat with a certain amount of legroom. As another example, user preference data can indicate that a passenger prefers certain amenities associated with a flight service (e.g., food offerings, drink offerings, entertainment offerings, etc.).

At 704, the method 700 can include obtaining, based at least in part on the user data, aviation data for one or more aviation service providers. Aviation service providers can include airline operator(s) (e.g., regional and/or national airlines, etc.), flight facility operators (e.g., airport operators, vertiport operators, etc.), and/or other types of aviation service providers. In some implementations, the aviation data can be obtained by generating an aviation data request based at least in part on the user data. The aviation data request can be configured to request the aviation data from the one or more aviation data service providers. As an example, the operations computing system of the multimodal transportation service can, in some implementations, receive a message format for the aviation data request (e.g., a particular Javascript Object Notation format, HTTP method, verification key, etc.) based on one or more calls to an application programming interface associated with the airline service provider(s). The operations computing system can generate and send an aviation data request based on the user data and the message format. The aviation data request can be configured to request the aviation data from the aviation service provider(s) based at least in part on the user data and by including at least a portion of the user data in the request. The aviation data can be received by the operations computing system of the multimodal transportation service provider in response to the aviation data request.

The aviation data can include one or more aviation service characteristics (e.g., flight facility maps, airline itineraries, etc.) associated with each aviation service provider of the one or more aviation service providers. In some implementations, the aviation service characteristic(s) can include flight facility operator mapping data. Flight facility operator mapping data can include a mapped representation of a flight facility. The mapping data can represent the flight facility using any preferred perspective, dimensionality, and/or level of interactivity. As an example, the mapping data can include a static, top-down, two-dimensional representation of a flight facility and the various services (e.g., restaurants, terminals, family friendly bathrooms, etc.) offered inside and/or around the flight facility. As another example, the mapping data can include a three-dimensional, interactive representation of the flight facility that can be modified (e.g., highlighting the location of a service, etc.) based on received inputs (e.g., a user input, etc.). As yet another example, the mapping data can include a virtual reconstruction of the flight facility that is navigable from a user computing device (e.g., a virtual “tour” of the flight facility, etc.).

In some implementations, the flight facility mapping data can more particularly include additional information regarding the service(s) provided by the flight facility operator. As an example, the flight facility mapping data can include menus for restaurants located in the flight facility and/or products offered in various shops located in the flight facility. In some implementations, as will be discussed in greater detail with regard to the figures, the flight facility operator mapping data can be provided to a user device for display to the user in an interactive manner. The user can interact with the displayed mapping data to communicate service requests to the multimodal transportation service provider (e.g., through an associated application, etc.) and/or service providers associated with the multimodal transportation service provider (e.g., food ordering services, autonomous food delivery services, etc.). As an example, if mapping data provided for display to the user includes a menu for a restaurant located in the flight terminal, the user can interact with the menu to request food be prepared in advance for the user. The user request can be received by the multimodal transportation service provider and, in some implementations, can be communicated to the flight facility operator and/or associated service provider(s) (e.g., restaurants, shops, etc.).

In some implementations, the aviation service characteristic(s) can include flight facility operator capability data that describes one or more capabilities of the flight facility operator. Operator capabilities can include flight facility transportation services (e.g., trams, shuttles, taxis, terminal parking, etc.), handicap accessibility (e.g., wheelchair ramps, medical accommodations, etc.), food offerings (e.g., vegetarian options, allergen-free options, etc.), offered services (e.g., travel agents, currency exchanges, customer services, etc.), or any other capabilities of the flight facility operator. As an example, the flight facility operator capability data can indicate that a flight facility does possesses the accessibility infrastructure necessary to service a handicap user. As another example, the flight facility operator capability data can indicate that a flight facility operator provides multiple food offerings for users with severe nut allergies. In addition, the operator capability data can indicate whether a flight facility allows for direct air transportation of users. As an example, the capability data can indicate that an aerial vehicle of the multimodal transportation service (e.g., a helicopter, a VTOL craft, etc.) can land in or on an area of the flight facility (potentially beyond a security checkpoint).

In some implementations, the aviation service characteristic(s) can include airline capability data. Airline capability data can describe the capabilities of the airline operator in a substantially similar fashion as the flight facility operator capability data, as discussed above. Further, the airline capability data can indicate specific capabilities of the flight services of the airline operator (e.g., in-flight entertainment offerings, seats with more leg room, first class upgrades, etc.). For example, the airline capability data may indicate that a flight service of the airline operator has food offerings for passengers with certain food restrictions, or that a flight service is wheelchair accessible. In addition, the airline capability data can indicate whether the airline permits users to disembark an aerial vehicle of a multimodal transportation service and directly board a flight service of the airline operator.

In some implementations, the aviation service characteristic(s) can include airline itinerary data. Airline itinerary data can describe a departure time, departure location, arrival time, and/or arrival location of a flight service provided by the airline operator. The airline itinerary data can also describe any modifications to the aforementioned aspects of the flight service. As an example, the airline itinerary data can indicate that a flight service has a departure time of 3:00 pm at a terminal 15 of a flight facility. As another example, the airline itinerary data can indicate that the flight service departure time has been modified to 3:45 p.m. In such fashion, the aviation service characteristics can indicate any changes or modifications (e.g., delays, early arrivals, etc.) to airline service(s) offered to the user.

At 706, the method 700 can include determining one or more service actions to perform based on the user data and the aviation data. Service action(s) can include multimodal transportation service itinerary adjustment(s). In some implementations, multimodal transportation service itinerary adjustment(s) can include adjusting at least one of the start time, the end time, the start location, the destination location, and/or the mode of transportation for at least one transportation segment of the itinerary. As an example, an itinerary adjustment may adjust a start time for a transportation segment from 3:15 p.m. to 3:45 p.m. because the user status data includes a user location that indicates the user will not arrive to the start location on time.

In some implementations, the multimodal transportation service itinerary adjustment(s) can include generating one or more contingency transportation segments for a transportation segment of the itinerary. More particularly, contingency transportation segment(s) can correspond with a transportation segment if the contingency segment provides an alternative for the transportation segment. The contingency transportation segment(s) can differ from the transportation segment in any manner (e.g., start time, end time, destination location, start location, mode of transportation, etc.). If a plurality of contingency transportation segments are generated, each contingency transportation segment of the plurality of contingency transportation segments can differ in at least one aspect (e.g., start time, end time, destination location, etc.). As an example, a transportation segment can include a start time of 3:00 p.m and a first route. A contingency transportation segment can be generated that includes a 3:30 p.m. start time and second route. As another example, if user data indicates that a user may not arrive by the start time of a transportation segment, a contingency transportation segment can be generated that will deliver the user to the destination location in an acceptable amount of time. In such fashion, contingency transportation segment(s) can be selected for predicted (e.g., based on user data and/or aviation data) and/or unforeseen incidents that can render a transportation segment unviable. The contingency transportation segment(s) can be selected based on the reason that the transportation segment is being replaced.

In some implementations, a contingency segment can be generated based on aviation data. More particularly, a contingency segment can be generated in response to aviation data that indicates changes to an aviation service. As an example, aviation data can indicate that a flight service was delayed by 1 hour. In response, a contingency segment can be generated with a correspondingly delayed start time. This can include, for example, assigning the user to an aerial vehicle that leaves at a later time than the user's originally scheduled aerial transport leg of the user's multimodal transportation service. In such fashion, contingency segment(s) can be generated in response to aviation data that indicates a change to a previously scheduled service, allowing a multimodal transportation itinerary adjustment to be selected from the one or more prepared contingency segment(s).

In some implementations, a contingency segment can be selected for a multimodal transportation itinerary adjustment. The selection can, as an example, be performed by the operations computing system. For example, a contingency segment can be selected by the operations computing system based on a metric or an evaluation of multiple metrics (e.g., speed, efficiency, vehicles available, user satisfaction, etc.). In some implementations, the one or more contingencies can be presented to a user and the user can select a contingency segment. As an example, aviation data can indicate a 1-hour delay for a flight service scheduled for a user. The operations computing system can provide for display (e.g., by an associated application on a user computing device) contingency segments generated based on the 1-hour delay. The user can select (e.g., using a touch command, voice command, etc.) a desired contingency segment. This can include, for example, selecting a later departure time for the user's first transportation segment, a later flight departure time for the user's aerial transportation segment, etc. Information associated with the respective contingency segments can be provided to the user for display in conjunction with the contingency segment(s). As an example, three contingency segments can be presented to the user, each including a respective time of arrival, service cost, service cost reduction, mode of transportation, departure time, etc. In such fashion, the user can determine the most optimal contingency setting based on the user's own preferences.

In some implementations, the multimodal transportation service itinerary can be stored as a data structure that includes the transportation segment(s) of a multimodal transportation service in addition to other ancillary information (e.g., seating arrangements for an associated flight, luggage dimensions, etc.). User data can be included in the multimodal transportation service itinerary and/or associated with the multimodal transportation service itinerary (e.g., through a relational database association, etc.). The data structure can be stored in memory in a computing system associated with the multimodal transportation service provider (e.g., an operations computing system, etc.). Additionally, or alternatively, the multimodal transportation service itinerary can be stored in memory on a user device associated with the user (e.g., a smartphone, smart watch, laptop, etc.).

The one or more service actions can further include security process modification(s). Security process modification(s) can include adding security process(es) and/or removing security process(es). Security process(es) can include governmental security processes (e.g., background checks, TSA security checkpoints, no-fly lists, etc.), multimodal transportation service security processes (e.g., a security checkpoint at an associated VTOL vertiport, helipad, etc.), and/or flight facility security processes (e.g., additional, non-governmental security processes operated by the flight facility operator). Security process modification(s) can be based on user data and/or aviation data. As an example, user data can indicate that a user has undergone a security process (e.g., at a facility associated with the multimodal transportation service provider, etc.) that is sufficient to bypass additional governmental security process(es) and/or flight facility security process(es) (e.g., at an airport). Based on the user data, a security process modification can remove the governmental security process requirement, enabling the user to bypass security process(es) at the flight facility.

It should be noted that the addition or removal of security processes can, in some implementations, have an effect on the multimodal transportation service itinerary. As an example, the removal of a security process can make more time available for the delivery of the multimodal transportation service. If more time is made available, the multimodal transportation service itinerary can be modified in response (e.g., adjusting a start time, etc.). As another example, the addition of a security process can make less time available for the delivery of the multimodal transportation service. If less time is made available, the multimodal transportation service itinerary can be modified in response (e.g., changing a mode of transport from a slower autonomous vehicle to a faster VTOL craft, accelerating a start time, etc.).

The one or more service actions can further include user service optimization(s) for the multimodal transportation service or the aviation service(s). In some implementations, user service optimization(s) can include requesting one or more modifications to an airline service provided by an airline service provider. More particularly, the optimization(s) can include a request that the airline service provider modify a characteristic of an airline service offered to a user. As an example, the user service optimization may request that a flight facility operator prepare certain accessibility accommodations (e.g., wheelchairs, etc.) for an arriving user. As another example, the user service optimization may include a request that an airline operator provide vegetarian food offerings onboard a flight.

In some implementations, user service optimization(s) can include modifying a terminal map associated with a flight facility operator. The terminal map can be a representational mapping of the flight facility, as discussed previously. As an example, the user service optimization may modify the terminal map to highlight vegetarian food offerings based on historical user data indicating the user is a vegetarian (e.g., provided in a user's food deliver service profile associated with the multimodal transportation service provider). As another example, the user service optimization may modify the terminal map to highlight a closed section of the flight facility based on aviation data indicating that the section is undergoing maintenance. As yet another example, the user service optimization may modify the terminal map to highlight the most efficient route for the user to navigate towards a certain terminal based on aviation data indicating that the terminal services the users flight service (e.g., for a user with a short timeframe to board a flight, a user traveling with children, etc.). The terminal map can be modified in any manner that optimizes the delivery of service(s) to the user. The terminal map can, in some implementations, be communicated to a user device of the user for display. More particularly, the terminal map can be communicated by the operations computing system of the multimodal transportation service to the user device (e.g., to an associated application on the user device, etc.) that displays the map and associated modifications. As an example, the map can be communicated to a user smartphone that displays the modified map to the user.

In some implementations, the user service optimization(s) can include modifying a flight provided by an airline operator based on an aggregation of user data for a flight service. More particularly, the operations computing system can determine that a plurality of users are each scheduled for the same flight service based on an aggregation of user data from the respective users. The user service optimization(s) can modify certain aspects of the flight, such as departure times, arrival times, seating arrangements, etc. As an example, if a majority of passengers of a flight service are users of the transportation service provider, the user service optimization(s) may modify the departure time of a flight to leave fifteen minutes earlier than previously planned. As another example, the user service optimization(s) may modify the seating arrangements of the flight (e.g., to provide a user a window seat, to seat a late user towards the front of the flight vehicle, etc.). The flight modifications can, in some implementations, be communicated to a user device of the user for display. More particularly, the flight modifications can be communicated by the operations computing system of the multimodal transportation service to the user device (e.g., to an associated application on the user device, etc.) that displays information indicating the modifications made to the flight. As an example, a modified departure time can be communicated to a user smartphone that displays information indicating the modified departure time to the user.

In some implementations, the user service optimization(s) can include providing an offer from an airline service to a user device of the user for display. Airline service providers can provide offers to the operations computing system of the multimodal transportation service, which can then be provided to the user device of the user for display. An aviation service provider can provide offers related to any provided service (e.g., flight ticket discounts, food service discounts, terminal parking discounts, on-flight WiFi discounts). As an example, aviation data can indicate that a flight is overbooked. An airline service provider can offer to move the user to a different flight in return for a reduced ticket price. As another example, historical user data can indicate that the user prefers vegetarian food offerings. In response, a flight facility operator can offer a coupon for vegetarian-oriented restaurants located inside the flight facility. As yet another example, historical user data can indicate that a user typically utilizes in-flight WiFi services. In response, the airline operator can offer a coupon for purchasing in-flight WiFi services to the user.

At 708, the method 700 can include performing the one or more service actions. Performance of the service action(s) can include, for example, modifying a multimodal transportation service itinerary, requesting modifications from airline service provider(s), communicating information to a user device associated with a user, etc. More particularly, the multimodal transportation service itinerary can be or otherwise include data structure(s) (e.g., array(s), hash map(s), tables, stacks, queues, etc.) to hold and/or organize parameters of a user's scheduled multimodal transportation service. The parameters (e.g., arrival times, departure times, modes of transportation, etc.) of the multimodal transportation service itinerary can be adjusted. As an example, an arrival time parameter included in the multimodal transportation service itinerary can be modified by the service action (e.g., changing value(s) in a data structure associated with the multimodal transportation service itinerary, etc.).

Further, communication of information to a user device associated with a user can be accomplished through one or more backend services of the multimodal transportation service provider or the aviation service provider. As an example, applications associated with either the multimodal transportation service provider or the aviation service provider can be installed on a user device associated with the user (e.g., a smartphone, a laptop, etc.). Information (e.g., modified multimodal transportation service itineraries, flight facility mapping data, etc.) can be communicated to the user device for display to the user. As an example, a flight facility operator can modify flight facility mapping data to highlight a route from a user's current location to a bathroom and send the flight facility mapping data to the user device. The flight facility mapping data can, in some implementations, be displayed on the user device using a user interface of an application (e.g., an application associated with a service provider, etc.).

Alternatively, or additionally, the flight facility operator can send the modified flight facility mapping data to the multimodal transportation service provider, who can send the mapping data to the user device for display to the user (e.g., using an associated application, etc.). Communication of information between the user and the service(s) can be accomplished using backend communication channels over network connection(s) for each service (e.g., application programming interfaces, etc.). As an example, the multimodal transportation service provider can obtain flight facility mapping data via one or more application programming interfaces (APIs) configured to receive such data. As another example, the multimodal transportation service provider can communicate the flight facility mapping data to the user device (e.g., an associated application, etc.) using one or more proprietary data communication channels (e.g., private APIs, websockets, etc.). In such fashion, the service provider(s) can communicate data with the user.

Similarly, modification requests can be communicated from the multimodal transportation service provider to the aviation service provider(s) over one or more networks and using one or more interfaces (e.g., application programming interfaces, sockets, etc.). As an example, the multimodal transportation service provider can send a request to an airline service provider requesting that a user's flight service departure time be modified. The request can be sent over a network via one or more APIs (e.g., websockets, REST APIs, etc.) associated with the airline service provider. In some implementations, the airline service provider can return data in response to the request that indicates whether the modification will be performed. For example, the airline service provider can return a message over the same or similar communication channels indicating that the airline service provider has modified the departure time of the flight service for the user. In such fashion, the multimodal transportation service can more easily incorporate flight services into the planning of multimodal transportation service itineraries.

FIG. 8 depicts a flowchart diagram of an example method 800 for generating an aviation data request according to example embodiments of the present disclosure. One or more portion(s) of the operations of method 800 can be implemented by one or more computing systems that include, for example, one or more portions of an operations computing system (e.g., operations computing system 102, etc.). Each respective portion of the method 800 can be performed by any (or any combination) of the computing device(s) of the respective computing system. Moreover, one or more portion(s) of the method 800 can be implemented as an algorithm on the hardware components of the device(s) described herein, for example, to facilitate communication between multimodal transportation service providers and aviation service providers. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 802, the method 800 can include receiving, based on one or more calls to an application programming interface, a message format for the aviation data request. The message format can be, for example, a particular Javascript Object Notation format, HTTP method, verification key, or any sort of other digital message format. The message format can be received based on one or more calls to an application programming interface associated with the airline service provider(s).

At 804, the method 800 can include generating the aviation data request. The aviation data request can be based at least in part on the user data and the message format. The aviation data request can be configured to request the aviation data from the one or more aviation service providers. More particularly, the aviation data request can be generated in a format that is compatible with one or more application programming interfaces associated with the aviation service providers. As an example, a flight facility operator may have an associated API that provides aviation data in response to a JSON data request that is formatted in a certain manner, includes a certain encryption key/standard, etc.

At 806, the method 800 can include sending the aviation data request to one or more computing systems of the aviation service provider(s). The aviation data request can include at least a portion of the user data (e.g., user identifier 302 of FIG. 3, etc.). More particularly, the aviation data request can, in some implementations, include data and/or information that identifies the user to a level sufficient as to enable the aviation service provider(s) to identify one or more services the aviation service provider(s) are scheduled to provide to the user. As an example, the user data included in the aviation request can include a user identifier recognized by the aviation service provider(s). Based on the user identifier, the aviation service provider(s) can determine a flight service that is scheduled for the user by an airline service provider.

At 808, the method 800 can include receiving the aviation data. The aviation data can be based at least in part on the aviation data request. The aviation data can include one or more aviation service characteristics associated with the aviation service provider(s), as discussed previously with regards to FIG. 7.

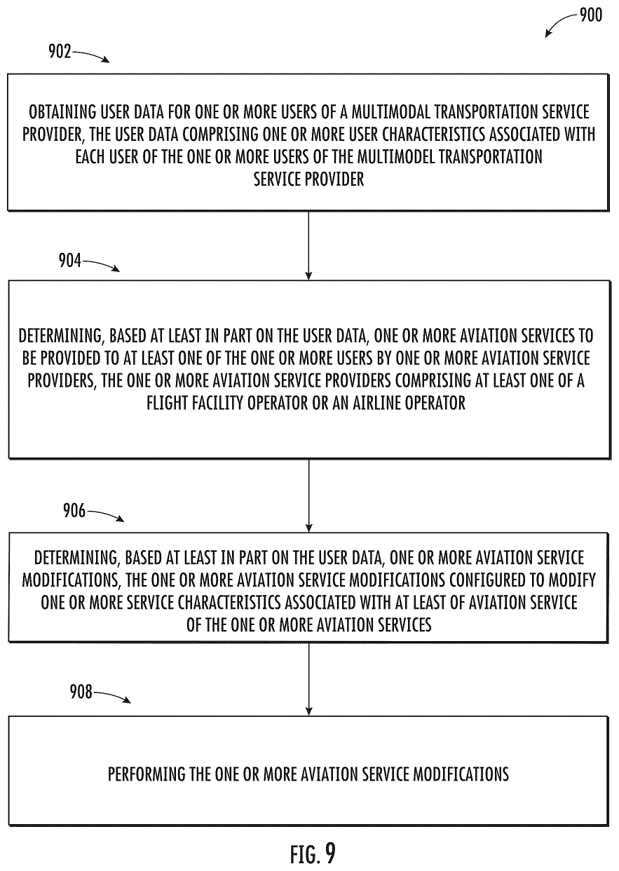

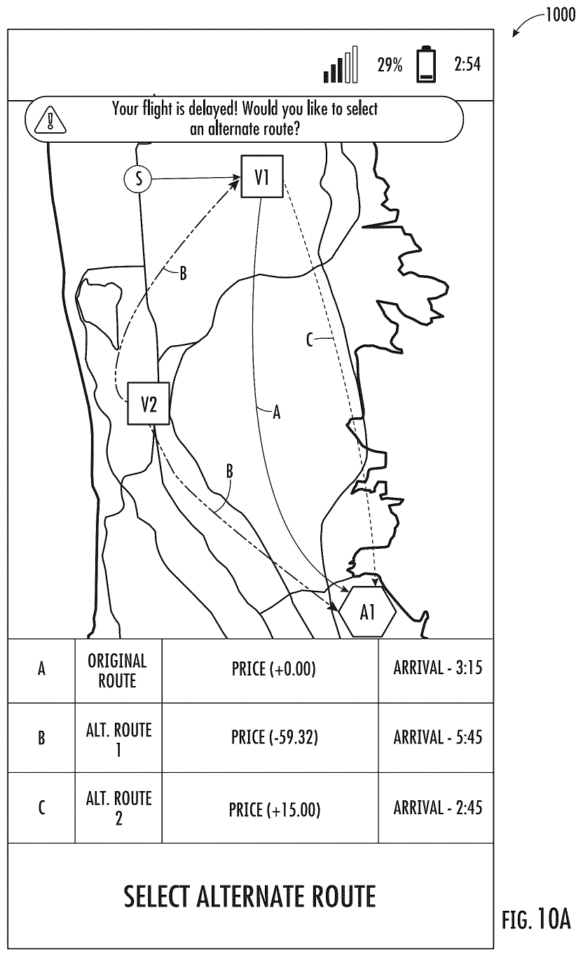

FIG. 9 depicts a flowchart diagram of an example method 900 for generating an aviation data request according to example embodiments of the present disclosure. One or more portion(s) of the operations of method 900 can be implemented by one or more computing systems that include, for example, one or more portions of an operations computing system (e.g., operations computing system 102, etc.). Each respective portion of the method 900 can be performed by any (or any combination) of the computing device(s) of the respective computing system. Moreover, one or more portion(s) of the method 900 can be implemented as an algorithm on the hardware components of the device(s) described herein, for example, to facilitate optimization of services provided to user(s). FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 902, the method 900 can include obtaining passenger data for one or more users of a multimodal transportation service provider. The passenger data can include one or more passenger characteristics associated with each user of the one or more users of the multimodal transportation service provider. In some implementations, passenger characteristics can include luggage measurement data. Luggage measurement data can describe the weight and dimensions of the piece(s) of luggage of user(s) of the multimodal transportation service. As an example, the luggage measurement data can indicate that a user is carrying a piece of luggage that weighs 45 pounds and is 21 inches wide, 21 inches high, and 14 inches deep. The luggage measurement data can, in some implementations, be collected at a transportation facility operated by or associated with the multimodal transportation provider (e.g., a VTOL vertiport, helipad, etc.).

In some implementations, the computing system of the aviation service provider can make a food purchasing determination for passenger(s). More particularly, the computing system can utilize the passenger status data to determine (e.g., using one or more algorithm(s), heuristic(s), machine-learned model(s), etc.) whether the passenger has recently purchased food (e.g., if the passenger purchased food at a transportation service facility, etc.). In response to this determination, the computing system can modify one or more characteristics of the aviation services offered. As an example, if a user is determined to have recently eaten, a flight service provider can reduce the amount of food loaded onto the airplane performing the user's flight service.

In some implementations, the one or more passenger characteristics can include historical data. Historical data can indicate historical user(s) preferences, statuses, and other historical user(s) behavior(s). As an example, historical data may indicate that user(s) is/are historically late or early when arriving at a terminal. As another example, historical data may indicate that user(s) generally prefer to utilize in-flight WiFi options. As yet another example, historical data may indicate that user(s) rarely consume food offerings offered onboard a flight service.

In some implementations, the one or more passenger characteristics can include security data. Security data can indicate a security clearance level associated with user(s). As an example, the security data can indicate that user(s) have undergone security procedure(s) (e.g., at a multimodal transportation service facility, etc.) of a sufficient security level to bypass governmental security checks (e.g., airport security checks, etc.) and/or aviation service provider(s) security checks. In such fashion, the airline service provider(s) can verify the security status of user(s) and allow user(s) to bypass security process(es) inside the flight facility.

In some implementations, the one or more passenger characteristics can include itinerary data. Itinerary data can indicate the travel itinerary of each user of the one or more users. The travel itinerary of the user(s) can indicate an arrival time, a current location, flight information, a mode of transportation, and/or any travel contingencies. As an example, the itinerary data may indicate that all user(s) of the multimodal transportation service will arrive by the departure time of the flight. As another example, the itinerary data may indicate that all user(s) of the multimodal transportation service are arriving in an aerial vehicle (e.g., VTOL craft, helicopter, etc.). As yet another example, the itinerary data may indicate that at least some user(s) will arrive after the departure time of the flight.

At 904, the method 900 can include determining, based on passenger data, one or more aviation services to be provided to at least one of the user(s) of the multimodal transportation service. More particularly, the aviation service(s) can identify the aviation service(s) that are scheduled to be and/or can be offered to the user(s) of the multimodal transportation service based on the user data. The one or more aviation services can be provided by a flight facility operator and/or an airline operator.

In some implementations, the aviation service(s) can include a flight service. The flight service can include one or more flight service characteristics. The flight service characteristic(s) can include any determinable aspect of the flight service to be offered, such as a passenger seating arrangement, on-board food offerings, a flight departure time, a flight fuel allocation, a flight luggage distribution, a flight vehicle used, a flight boarding time, etc. As an example, the flight service characteristic(s) for a certain flight can include a departure time of 3:00 pm, a boarding time of 2:35 p.m, a certain flight vehicle (e.g., a large passenger jet, etc.), and vegetarian food offerings.

In some implementations, the aviation service(s) can include a security process. The security process can include one or more security characteristics. The security characteristic(s) can indicate security process requirements and statuses. As an example, the security characteristic(s) may indicate that each passenger of a flight service is required to pass through an airline service mandated security procedure. As another example, the security characteristic(s) may indicate that passengers are not required to pass through a flight facility operator mandated security procedure or may indicate that passengers have already done so.

In some implementations, the aviation service(s) can include one or more flight facility travel services. The flight facility travel service(s) can include service(s) that provide transportation for passengers to, from, and around the flight facility (e.g., trams, shuttles, light rails, handicap pickup and drop-off, parking, etc.). The flight facility travel service(s) can include one or more travel service characteristics. The travel service characteristics can include and/or indicate departure times, arrival times, start locations, destination locations, and capabilities (e.g., handicap access, etc.) of the travel service(s) offered to passengers. As an example, travel service characteristic(s) may include a start time of 3:00 pm for a parking lot shuttle of the flight facility operator.

In some implementations, the aviation service(s) can include accommodations. Accommodations can include lodgings (hotels, motels, hostels, etc.) that are offered by or associated with aviation service provider(s). As an example, a flight facility may include a hotel. As another example, an airline service may be associated with a local hotel or motel. Accommodations can include accommodation characteristics, such as room selection, length of stay, room upgrades, room amenities, etc.

At 906, the method 900 can include determining, based on passenger data, one or more aviation service modifications. The aviation service modification(s) can be configured to modify one or more service characteristics associated with at least one aviation service of the aviation service(s). More particularly, different characteristics of the aviation service(s) (e.g., flight services, accommodations, security processes, food services, travel services, etc.) can be modified based on the passenger data. As an example, the departure time of a flight service can be modified based on passenger data indicating passenger(s) of the flight service will be late. As another example, security process requirements can be modified (e.g., removed, etc.) based on passenger data indicating a passenger has been pre-cleared by another security process. As yet another example, travel service vehicles can be modified (e.g., replacing a scheduled shuttle with a handicap-accessible shuttle, etc.) based on passenger data indicating that a passenger is handicapped. Accommodations, for example, can be modified (e.g., applying a room upgrade) based on user data indicating that certain users are frequent visitors of the flight facility. Luggage distribution in the plane, for example, can be modified based on the dimensions of user(s) luggage.

In some implementations, the one or more users of the multimodal transportation service provider can include a plurality of users. The computing system of the aviation service provider(s) can determine, based on the passenger data, one or more aviation services to be offered to the plurality of passengers. As an example, a flight service can be determined to have been scheduled for each passenger of the plurality of passengers. Based on the passenger data for each user of the plurality of users, one or more aviation service modifications can be determined. The aviation service modification(s) can be configured to modify service characteristic(s) associated with the aviation service, as discussed previously.

More particularly, if an aviation service is determined to be offered to each user of the multimodal transportation service, modification(s) can be applied based on the passenger data for each user. As an example, passenger data can indicate that each user of the multimodal transportation service will most likely arrive after the scheduled departure time of a flight service. In response, the departure time of the flight service can be modified so that the flight departs after all users arrive at the flight facility. In such fashion, the aviation service provider(s) can modify aviation service(s) based on a number of users and shared commonalities between users of a multimodal transportation service.

At 908, the method 900 can include performing the one or more aviation service modifications. The aviation service modification(s) can be performed by the computing system associated with the aviation service provider(s). Performance of the aviation service modifications(s) can include, for example, modifying aviation service characteristic(s) (e.g., modifying flight departure times, rescheduling flight facility travel services, etc.). The aviation service modification(s) can be communicated to at least one of the user(s) of the multimodal transportation service provider. More particularly, data indicating the modification(s) performed can be communicated (e.g., through an associated application, etc.) to a user device for display to the user. As an example, data indicating a modified departure time can be communicated to the device of a user and then displayed to the user.

FIG. 10A depicts an example user interface 1000 for displaying contingency transportation segments to a user according to example embodiments of the present disclosure. More particularly, the user interface 1000, as depicted, can be the user interface of an application associated with the multimodal transportation service provider (e.g., an application for a multimodal rideshare service, etc.) as displayed on a user computing device 1000 (e.g., a tablet, smartphone, etc.). The user interface 1000 of the present example depicts an interface configured to present transportation segment(s) (e.g., segment A) and contingency transportation segment(s) (e.g., segment B, segment C, etc.) to a user. The contingency transportation segments can be generated based on a number of events. In the present example, the user interface 1000 depicts a notification that the flight service to be offered to the user has been delayed. In response to the delay, contingency segments B and C can be generated and provided to the interface of the user interface 1000. It should be noted that although the present example depicts a user selection of contingency transportation segments, the selection of a contingency transportation segment can be performed by the operations computing system of the multimodal transportation service provider.

As depicted, the user can be offered a choice between contingency transportation segments B and C in response to the users flight service delay. In some implementations, the contingency transportation segments can be associated with reduced costs (e.g., a cost associated with the transportation service offered) and modified arrival times. As an example, if the user selects transportation segment A, the cost of the transportation service will not change, and the arrival time of the user will continue to be 3:15. If the user selects contingency transportation segment B, the user can reduce the overall cost of the transportation service by $59.32 and delay the arrival time to 5:45. As yet another example, if the user selects contingency transportation segment C, the user can increase the cost of the transportation service by $15.00 and accelerate the arrival time to 2:45. In such fashion, the user can select the transportation segment that is most optimal for the user (e.g., based on user costs, user flight service timing, user preferences, etc.).

FIG. 10B depicts an example user interface for displaying terminal map data to a user according to example embodiments of the present disclosure. More particularly, the user interface 1000, as depicted, can be the user interface of an application associated with the multimodal transportation service provider (e.g., an application for a multimodal rideshare service, etc.) as displayed on the user interface 1000 (e.g., a tablet, smartphone, etc.). The user interface 1000 of the present example depicts an interface configured to display received flight facility mapping data to a user.

The flight facility mapping data can include a mapped representation of a flight facility. The mapping data can represent the flight facility using any preferred perspective, dimensionality, and/or level of interactivity. As an example, the mapping data can include a static, top-down, two-dimensional representation of a flight facility and the various services (e.g., restaurants, terminals, family friendly bathrooms, etc.) offered inside and/or around the flight facility. As another example, the mapping data can include a three-dimensional, interactive representation of the flight facility that can be modified (e.g., highlighting the location of a service, etc.) based on received inputs (e.g., a user input, etc.). As yet another example, the mapping data can include a virtual reconstruction of the flight facility that is navigable from a user computing device (e.g., a virtual “tour” of the flight facility, etc.).

As depicted, the user interface 1000 depicts a 2-dimensional top-down representation of the flight facility mapping data. The user interface includes interactive objects (e.g., A, B, C) that the user can interact with to highlight various portions of the mapping data. As an example, the user can select object A to highlight a route A that will navigate the user to their terminal gate. As another example, the user can select object B to highlight restaurants offered inside the flight facility. In some implementations, the restaurants highlighted by object B can be highlighted in accordance with the user's preferences. For example, if the user in question was vegetarian, the object B could highlight vegetarian restaurants nearby the user. As yet another example, object C can allow the user to search the map for specific locations and/or services the user desires. In such fashion, the user computing device 1000 can display an interface to the user including mapping data that allows the user to easily navigate the flight facility to access locations and/or services that are customized based on the user's preferences.

It should be noted that the options presented to the user (e.g., options A, B, and C) are merely depicted to illustrate the functionality of the user interface of the user computing device 1000. The depicted options are not necessarily required for the user interface, and other options can additionally and/or alternatively be presented to the user. Similarly, the interactive object format is merely depicted to illustrate the functionality of the mapping data. The command to highlight certain features of the mapping data and/or to otherwise interact with the mapping data can be facilitated in any other manner (e.g., user voice commands, automatic highlighting by the operations computing system, etc.).

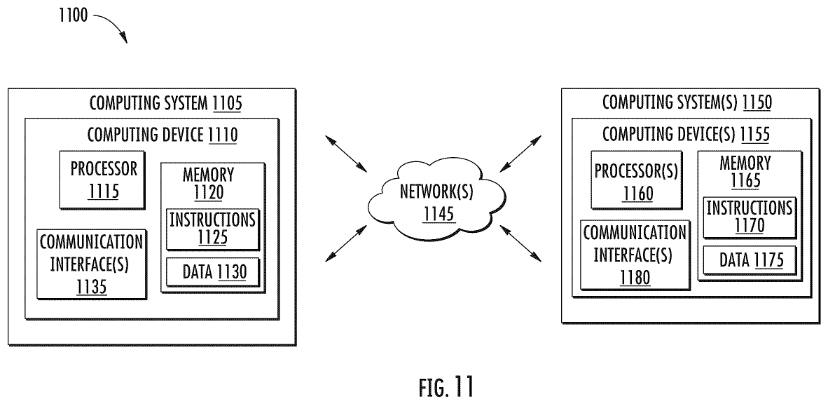

FIG. 11 depicts example system components of an example system 1100 according to example implementations of the present disclosure. The example system 1100 illustrated in FIG. 11 is provided as an example only. The components, systems, connections, and/or other aspects illustrated in FIG. 11 are optional and are provided as examples of what is possible, but not required, to implement the present disclosure. The example system 1100 can include a computing system 1105 and a computing system 1150 (e.g., multimodal transportation service provider operations computing system 102, aviation service provider computing system 108, one or more vehicle computing system(s), etc.) that are communicatively coupled over one or more network(s) 1145 (e.g., network 112, etc.).

The computing system 1105 can include one or computing device(s) 1110. The computing device(s) 1110 of the computing system 1105 can include processor(s) 1115 and a memory 1120. The one or more processor(s) 1115 can be any suitable processing device (e.g., a processor core, a microprocessor, an ASIC, a FPGA, a controller, a microcontroller, etc.) and can be one processor or a plurality of processors that are operatively connected. The memory 1120 can include one or more non-transitory computer-readable storage media, such as RAM, ROM, EEPROM, EPROM, one or more memory devices, flash memory devices, etc., and/or combinations thereof.

The memory 1120 can store information that can be obtained by the one or more processor(s) 1115. For instance, the memory 1120 (e.g., one or more non-transitory computer-readable storage mediums, memory devices, etc.) can include computer-readable instructions 1125 that can be executed by the one or more processor(s) 1115. The instructions 1125 can be software written in any suitable programming language or can be implemented in hardware. Additionally, or alternatively, the instructions 1125 can be executed in logically and/or virtually separate threads on processor(s) 1115.

For example, the memory 1120 can store instructions 1125 that when executed by the one or more processor(s) 1115 cause the one or more processor(s) 1115 to perform operations. As an example, the operations can include any of the operations and functions of the operations computing system 102 (e.g., communicating with an aviation computing system, modifying a multimodal transportation service itinerary, etc.) or the aviation service provider computing system 108 (e.g., modifying one or more parameters of a flight service, communicating with a multimodal transportation service operations computing system, etc.).

The memory 1120 can store data 1130 that can be obtained (e.g., received, accessed, written, manipulated, generated, created, stored, etc.). The data 1130 can include, for instance, multimodal transportation segment itinerary data, user data, passenger data, aviation service characteristics, and/or other data/information described herein. In some implementations, the computing device(s) 1110 can obtain data from one or more memories that are remote from the computing system 1105. As an example, the computing device(s) 1110 can obtain data from transportation service vehicle(s), user computing device(s), associated computing system(s), multimodal transportation service operations facility(s), flight vehicle(s) (e.g., VTOLs, helicopters, airplanes, etc.), and/or other computing systems (e.g., computing system(s) 1150)

The computing device(s) 1110 can also include a communication interface 1135 used to communicate with one or more other system(s) (e.g., other systems onboard and/or remote from a vehicle, the other systems of FIG. 11, etc.). The communication interface 1135 can include any circuits, components, software, etc. for communicating via one or more network(s) (e.g., 1145). In some implementations, the communication interface 1135 can include, for example, one or more of a communications controller, receiver, transceiver, transmitter, port, conductors, software and/or hardware for communicating data/information.

The computing system 1150 can include one or more computing device(s) 1155. The computing device(s) 1155 can include one or more processor(s) 1160 and at least one memory 1165. The one or more processor(s) 1160 can be any suitable processing device (e.g., a processor core, a microprocessor, an ASIC, a FPGA, a controller, a microcontroller, etc.) and can be one processor or a plurality of processors that are operatively connected. The memory 1165 can include one or more tangible, non-transitory computer-readable storage media, such as RAM, ROM, EEPROM, EPROM, one or more memory devices, flash memory devices, data registers, etc., and combinations thereof.

The memory 1165 can store information that can be accessed by the one or more processor(s) 1160. For instance, the memory 1165 (e.g., one or more tangible, non-transitory computer-readable storage media, one or more memory devices, etc.) can include computer-readable instructions 1170 that can be executed by the one or more processor(s) 1160. The instructions 1170 can be software written in any suitable programming language or can be implemented in hardware. Additionally, or alternatively, the instructions 1170 can be executed in logically and/or virtually separate threads on processor(s) 1160.

For example, the memory 1165 can store instructions 1170 that when executed by the one or more processor(s) 1160 cause the one or more processor(s) 1160 to perform operations such as any of the operations and functions of the computing system 1105, the computing system 1150 and/or computing device(s) 1155, or for which any of these computing systems are configured, as described herein, operations and functions of the operations computing system 102, the aviation computing system 108, and/or any other operations and functions described herein.

The memory 1165 can store data 1175 that can be obtained and/or stored. The data 1175 can include, for instance, flight facility mapping data, flight facility operations data (e.g., food offerings, service offerings, etc.), flight facility transportation data (e.g., transportation service schedules, etc.), aviation service capability data, airline operations data, and/or other data/information as described herein. As an example, the computing device(s) 1155 can obtain data from transportation service vehicle(s), user computing device(s), associated computing system(s), multimodal transportation service operations facility(s), flight vehicle(s) (e.g., VTOLs, helicopters, airplanes, etc.), and/or other computing systems (e.g., computing system(s) 1105, etc.)

The computing device(s) 1155 can also include a communication interface 1180 used to communicate with one or more other system(s) (e.g., the vehicle computing system 1105, etc.). The communication interface 1180 can include any circuits, components, software, etc. for communicating via one or more networks (e.g., network(s) 1145). In some implementations, the communication interface 1180 can include, for example, one or more of a communications controller, receiver, transceiver, transmitter, port, conductors, software, and/or hardware for communicating data.

The network(s) 1145 can be any type of network or combination of networks that allows for communication between devices. In some embodiments, the network(s) 1145 can include one or more of a local area network, wide area network, the Internet, secure network, cellular network, mesh network, peer-to-peer communication link and/or some combination thereof and can include any number of wired or wireless links. Communication over the network(s) 1145 can be accomplished, for instance, via a network interface using any type of protocol, protection scheme, encoding, format, packaging, etc.

Computing tasks discussed herein as being performed at computing device(s) remote from an autonomous vehicle can instead be performed at a vehicle (e.g., a VTOL, ground-based autonomous vehicle, airplane, etc.) or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. (canceled)

2. A computing system, comprising:
one or more processors; and
one or more memories including instructions that, when executed by the one or more processors, cause the one or more processors to perform operations, the operations comprising:
accessing security data for a plurality of passengers of a vertical takeoff and landing (VTOL) aircraft;
computing, based on a call an application programming interface associated with a government security interface and the security data, a security authorization for the plurality of passengers to bypass a security checkpoint at an aerial facility;
computing a first landing location at an aerial facility for the VTOL aircraft, from among a plurality of potential landing locations, wherein the plurality of potential landing locations comprises: (i) the first landing location which is positioned beyond the security checkpoint of the aerial facility, and (ii) a second landing location which is positioned prior to the security checkpoint of the aerial facility,
wherein the security checkpoint is associated with a redundant security procedure for the plurality of passengers; and
routing the VTOL aircraft to the first landing location at the aerial facility, instead of the second landing location, to bypass the redundant security procedure for the plurality of passengers.

3. The computing system of claim 2, wherein the operations comprise:
computing, based on a call to another application programing interface, a formatted message for the airline operator, the formatted message indicating the first landing location of the VTOL aircraft.

4. The computing system of claim 2, wherein the operations comprise:
computing a modified itinerary of a passenger, of the plurality of passengers, by adjusting a data structure storing an itinerary of the passenger; and
providing, to a user computing device of the passenger, data indicative of the modified itinerary.

5. The computing system of claim 4, wherein the itinerary of the passenger comprises a first transportation segment and a second transportation segment, wherein the first transportation segment comprises transporting the passenger by the VTOL aircraft to the aerial facility, and wherein the second transportation segment comprises transporting the user via a flight of an airline operator, the airline operator being different than a VTOL aircraft provider associated with the first transportation segment.

6. The computing system of claim 2, wherein routing the VTOL aircraft to the first landing location at the aerial facility comprises re-routing the VTOL aircraft from the second landing location to the first landing location.

7. The computing system of claim 6, wherein the VTOL aircraft is inflight.

8. The computing system of claim 2, wherein routing the VTOL aircraft comprises instructing the VTOL aircraft to fly to the first landing location at the aerial facility.

9. The computing system of claim 2, wherein instructing the VTOL aircraft to fly to the first landing location comprises providing instructions to a computing device associated with the aircraft, the instructions indicating the first landing location as a destination for the VTOL aircraft.

10. The computing system of claim 2, wherein the computing device associated with the aircraft comprises a user computing device of the pilot.

11. A computer-implemented method, comprising:
accessing security data for a plurality of passengers of a vertical takeoff and landing (VTOL) aircraft;
computing, based on a call an application programming interface associated with a government security interface and the security data, a security authorization for the plurality of passengers to bypass a security checkpoint at an aerial facility;
computing a first landing location at an aerial facility for the VTOL aircraft, from among a plurality of potential landing locations, wherein the plurality of potential landing locations comprises: (i) the first landing location which is positioned beyond the security checkpoint of the aerial facility, and (ii) a second landing location which is positioned prior to the security checkpoint of the aerial facility,
wherein the security checkpoint is associated with a redundant security procedure for the plurality of passengers; and
routing the VTOL aircraft to the first landing location at the aerial facility, instead of the second landing location, to bypass the redundant security procedure for the plurality of passengers.

12. The computer-implemented method of claim 11 comprising:
computing, based on a call to another application programing interface, a formatted message for the airline operator, the formatted message indicating the first landing location of the VTOL aircraft.

13. The computer-implemented method of claim 11 comprising:
computing a modified itinerary of a passenger, of the plurality of passengers, by adjusting a data structure storing an itinerary of the passenger; and
providing, to a user computing device of the passenger, data indicative of the modified itinerary.

14. The computer-implemented method of claim 13 comprising, wherein the itinerary of the passenger comprises a first transportation segment and a second transportation segment, wherein the first transportation segment comprises transporting the passenger by the VTOL aircraft to the aerial facility, and wherein the second transportation segment comprises transporting the user via a flight of an airline operator, the airline operator being different than a VTOL aircraft provider associated with the first transportation segment.

15. The computer-implemented method of claim 11, wherein routing the VTOL aircraft to the first landing location at the aerial facility comprises re-routing the VTOL aircraft from the second landing location to the first landing location.

16. The computer-implemented method of claim 11, wherein routing the VTOL aircraft comprises instructing the VTOL aircraft to fly to the first landing location at the aerial facility.

17. The computer-implemented method of claim 11, wherein instructing the VTOL aircraft to fly to the first landing location comprises providing instructions to a computing device associated with the aircraft, the instructions indicating the first landing location as a destination for the VTOL aircraft.

18. The computer-implemented method of claim 11, wherein the computing device associated with the aircraft comprises a user computing device of the pilot.

19. One or more tangible, non-transitory computer readable media storing computer-readable instructions that are executable by one or more processors to cause the one or more processors to perform operations, the operations comprising:
accessing security data for a plurality of passengers of a vertical takeoff and landing (VTOL) aircraft;
computing, based on a call an application programming interface associated with a government security interface and the security data, a security authorization for the plurality of passengers to bypass a security checkpoint at an aerial facility;
computing a first landing location at an aerial facility for the VTOL aircraft, from among a plurality of potential landing locations, wherein the plurality of potential landing locations comprises: (i) the first landing location which is positioned beyond the security checkpoint of the aerial facility, and (ii) a second landing location which is positioned prior to the security checkpoint of the aerial facility,
wherein the security checkpoint is associated with a redundant security procedure for the plurality of passengers; and
routing the VTOL aircraft to the first landing location at the aerial facility, instead of the second landing location, to bypass the redundant security procedure for the plurality of passengers.

20. The one or more tangible, non-transitory computer-readable media of claim 19, wherein the operations comprise:
computing, based on a call to another application programing interface, a formatted message for the airline operator, the formatted message indicating the first landing location of the VTOL aircraft.

21. The one or more tangible, non-transitory computer-readable media of claim 19, wherein the operations comprise:
computing a modified itinerary of a passenger, of the plurality of passengers, by adjusting a data structure storing an itinerary of the passenger; and
providing, to a user computing device of the passenger, data indicative of the modified itinerary.
